(19) United States
(12) Patent Application Publication
(10) Pub. No.: US 2024/0373281 A1
(43) Pub. Date: Nov. 7, 2024

(54) DEVICE AND METHOD PERFORMED BY DEVICE IN A WIRELESS COMMUNICATION SYSTEM

(71) Applicant: Samsung Electronics Co., Ltd., Suwon-si (KR)

(72) Inventors: Weiwei WANG, Beijing (CN); Hong WANG, Beijing (CN); Lixiang XU, Beijing (CN)

(21) Appl. No.: 18/471,547

(22) Filed: Sep. 21, 2023

(30) Foreign Application Priority Data
May 5, 2023 (CN) 202310499356.3

(51) Int. Cl. H04W 28/02; H04W 28/24; H04W 72/543

(52) U.S. Cl. CPC H04W 28/0268; H04W 28/24; H04W 72/543

(57) ABSTRACT

The disclosure relates to a 5G or 6G communication system for supporting a higher data transmission rate. A method performed by a node (a device) in a wireless communication system, and a node (a device) are provided. A method performed by a first node in a wireless communication system is provided. The method includes acquiring time information related to data, and transmitting a first message to a second node based on the time information related to the data, wherein the first message includes identity information of the data and at least one configuration information.

### CROSS-REFERENCE TO RELATED APPLICATION(S)

This application is based on and claims priority under 35 U.S.C. § 119 (a) of a Chinese patent application number 202310499356.3, filed on May 5, 2023, in the Chinese Intellectual Property Office, the disclosure of which is incorporated by reference herein in its entirety.

### BACKGROUND

### 1. Field

The disclosure relates to a field of communications.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and method performed by a in a wireless communication system.

Additional aspects will be set forth in part in the description which follows and, in part, will be apparent from the description, or may be learned by practice of the presented embodiments.

In accordance with an aspect of the disclosure, a method performed by a second node in a wireless communication system is provided. The method includes receiving a first message from a first node, wherein the first message include identity information of data, at least one time information, and at least one configuration information corresponding to the at least one time information, and transmitting data indicated by the identity information of data based on the first message.

In various embodiments of the disclosure, in the method performed by the second node, the transmitting of data indicated by the identity information of data includes transmitting the data within time indicated by the at least one time information based on the at least one configuration information.

In various embodiments of the disclosure, in the method performed by the second node, the first message further includes at least one of first indication information for indicating one configuration information in the at least one configuration information, information for indicating associated data, information for indicating a mapping relationship of the data, information for indicating an applicable time range, and information for indicating a quality of service (QoS) parameter that the second node is requested to satisfy.

In various embodiments of the disclosure, the method performed by the second node further includes receiving a second message, wherein the second message includes second indication information for indicating one configuration information in the at least one configuration information.

In various embodiments of the disclosure, in the method performed by the second node, the at least one time information is used for indicating at least one time window and information related to the at least one time window, and the at least one configuration information includes information for indicating a setting of a QoS parameter applicable to the data within a time window indicated by the at least one time information, and/or information for indicating a configuration related to the data requested by the first node.

In accordance with another aspect of the disclosure, a method performed by a second node in a wireless communication system is provided. The method includes receiving a first message from a first node, wherein the first message includes identity information of data and at least one configuration information, receiving a second message, wherein the second message includes second indication information for indicating one configuration information in the at least one configuration information, and transmitting data indicated by the identity information of data according to the configuration information indicated by the second message and/or the first message.

In various embodiments of the disclosure, in the method performed by the second node, the second message is received from the first node or a third node.

In various embodiments of the disclosure, in the method performed by the second node, the data meets a QoS requirement corresponding to the time information, and parameters of the QoS requirement includes at least one of following parameters QoS priority level, packet delay budget (PDB), packet error rate (PER), QoS identity information, delay critical indication, averaging window, maximum data burst volume, allocation and retention priority, guaranteed bit rate (GBR) QoS flow information, and reflective QoS attribute.

In various embodiments of the disclosure, in the method performed by the second node, the first message further includes at least one of information for indicating associated data, information for indicating a mapping relationship of the data, information for indicating an applicable time range, and information for indicating a QoS parameter that the second node is requested to satisfy.

In various embodiments of the disclosure, in the method performed by the second node, the information for indicating the mapping relationship of the data includes at least one of information for indicating a mapping mode of data, identity information of input data, information for indicating time window information of the input data, identity information of output data, information for indicating whether to map the input data to default output data, and information for indicating a time window to which the information for indicating the mapping relationship of the data is applicable.

In various embodiments of the disclosure, in the method performed by the second node, a mapping mode indicated by the information for indicating the mapping mode of data includes at least one of time window-based mapping, data-based mapping, one-to-one mapping, and one-to-multiple mapping.

In various embodiments of the disclosure, in the method performed by the second node, the first node and the second node includes at least one of the first node is a base station, or a central unit of the base station, or a control plane portion of the central unit of the base station, or a user plane portion of the central unit of the base station, and the second node is a user equipment, the first node is the central unit of the base station, or the control plane portion of the central unit of the base station, or the user plane portion of the central unit of the base station, and the second node is a distributed unit of the base station, the first node is the control plane portion of the central unit of the base station, and the second node is the user plane portion of the central unit of the base station.

In various embodiments of the disclosure, the method performed by the second node further includes according to the time window to which the data received by the second node belongs, performing the following mapping the data to a corresponding RLC entity, and/or mapping the data to a corresponding logical channel, and/or making the data be served by a corresponding cell or cell group, and/or making the data be served according to a configuration corresponding to the time window.

In various embodiments of the disclosure, the method performed by the second node further includes the second node performing at least one of discarding data, deciding whether to discard data according to the configuration, mapping data, determining a configuration to be used according to information contained in received data, and/or receiving and/or transmitting data.

In various embodiments of the disclosure, in the method performed by the second node, the data includes at least one of information for indicating QoS information corresponding to the data, information for indicating the time window to which the data belongs, information for indicating whether the transmitted data is last data, information for indicating a configuration required to process the data, information for indicating whether a configuration for transmitting data needs to be suspended, information for indicating whether the configuration for transmitting data needs to be used continuously, information for indicating a start of the time window, information for indicating an end of the time window, and information for indicating a configuration used to transmit data that has not yet been transmitted after the time window ends.

In various embodiments of the disclosure, in the method performed by the second node, the first message further includes at least one time information corresponding to the at least one configuration information.

In various embodiments of the disclosure, in the method performed by the second node, the first indication information or the second indication information includes at least one of configuration identity information, information for indicating a time window, information for indicating a QoS parameter that the second node needs to adopt, information for indicating a transmission configuration that the second node needs to adopt, information for indicating a configuration of data that the second node needs to adopt, information for indicating a configuration that needs to be activated, and information for indicating a configuration that needs to be deactivated or suspended.

In accordance with another aspect of the disclosure, a method performed by a first node in a wireless communication system is provided. The method includes acquiring time information related to data, and sending a first message to a second node based on the time information related to data, wherein the first message includes identity information of the data and at least one configuration information.

In various embodiments of the disclosure, in the method performed by the first node, the first message further includes at least one time information corresponding to the at least one configuration information.

In various embodiments of the disclosure, in the method performed by the first node, the first message further includes first indication information for indicating one configuration information in the at least one configuration information.

In various embodiments of the disclosure, the method performed by the first node further includes sending a second message to the second node, wherein the second message includes second indication information for indicating one configuration information in the at least one configuration information.

In various embodiments of the disclosure, in the method performed by the first node, the first indication information or the second indication information includes at least one of configuration identity information, information for indicating a time window, information for indicating a QoS parameter that the second node needs to adopt, information for indicating a transmission configuration that the second node needs to adopt, information for indicating a configuration of data that the second node needs to adopt, information for indicating a configuration that needs to be activated, and information for indicating a configuration that needs to be deactivated or suspended.

In various embodiments of the disclosure, the method performed by the first node further includes sending a third message to a third node, wherein the third message includes time information and at least one configuration information, and receiving a fourth message from the third node.

In various embodiments of the disclosure, in the method performed by the first node, the time information related to data includes at least one of information for indicating at least one time window, information for indicating a setting of the QoS parameter applicable to the data within a time window, and information for indicating the configuration related to the data.

In various embodiments of the disclosure, in the method performed by the first node, the information for indicating at least one time window includes at least one of identity information of a time window, information for indicating a start position of the time window, information for indicating a length of the time window, information for indicating an end position of the time window, information for indicating an amount of data that needs to be and/or has been transmitted within the time window, information for indicating an offset required to start the time window, information for indicating a cycle of the time window, information for indicating the number of time windows, information for indicating whether the second node is able to continue to use the configuration information corresponding to the time window after the time window ends, information for indicating time allowed for the second node to continue data transmission according to a corresponding configuration after the time window ends, information for indicating the amount of data allowed for the second node to continue data transmission according to the corresponding configuration after the time window ends, and information for indicating a length of a timer related to the time window.

In various embodiments of the disclosure, in the method performed by the first node, the information for indicating the setting of the QoS parameter applicable to the data within a time window includes at least one of information for indicating the setting of the QoS parameter applicable to the data indicated by the identity information of data, information for indicating an optional QoS parameter applicable to the data indicated by the identity information of data, and identity information of the QoS parameter.

In various embodiments of the disclosure, in the method performed by the first node, the information for indicating the configuration related to the data includes at least one of configuration identity information, information for indicating a configuration required for data transmission, and information for indicating a configuration required when configuring data transmission.

In various embodiments of the disclosure, in the method performed by the first node, the information for indicating the configuration required for data transmission includes at least one of transmission configuration identity information, transport layer address information, and identity information of a tunnel endpoint. The information for indicating the configuration required when configuring data transmission includes at least one of identity information for identifying a set of configurations, information for indicating a cell serving the data, information for configuring configuration information required by the second node for data transmission, and information for indicating configuration information required to receive and/or transmit data.

In various embodiments of the disclosure, in the method performed by the first node, the information for indicating the amount of data that needs to be and/or has been transmitted within the time window includes at least one of information for indicating a total amount of data that needs to be transmitted, information for indicating an amount of data that has been transmitted, and information for indicating an amount of data that needs to be transmitted.

In various embodiments of the disclosure, in the method performed by the first node, the information for indicating a cell serving the data includes at least one of identity information of the cell, information for indicating a cell group, and identity information of the cell group.

In various embodiments of the disclosure, in the method performed by the first node, the information for configuring configuration information required by the second node for data transmission includes at least one of identity information of a bearer, a configuration of a packet data convergence protocol (PDCP) layer, a configuration of a radio link control (RLC), a configuration of a logical channel, a cell group configuration, a configuration of a bearer, and a configuration of an RLC bearer.

In various embodiments of the disclosure, in the method performed by the first node, the information for indicating configuration information required to receive and/or transmit data includes at least one of cycle information, counter information, offset information, and timer information.

In accordance with another aspect of the disclosure, a method performed by a third node in a wireless communication system is provided. The method includes receiving a third message from a first node, wherein the third message includes time information and at least one configuration information, and sending a second message to a second node, wherein the second message includes indication information for indicating one configuration information in the at least one configuration information.

In various embodiments of the disclosure, the method performed by the third node further includes sending a fourth message to the first node, the fourth message includes at least one of identity information of data, information for indicating a QoS parameter can be satisfied and/or a transmission configuration adopted and/or configuration information of data adopted by the second node within a time window, information for indicating a mapping mode of data adopted by the second node, and information for indicating the QoS parameter can be satisfied by the second node.

In various embodiments of the disclosure, in the method performed by the third node, the information for indicating a QoS parameter can be satisfied and/or a transmission configuration adopted and/or configuration information of data adopted by the second node within a time window includes at least one of information for indicating a time window that can meet a QoS requirement, information for indicating the QoS parameter that can be satisfied by the second node, information for indicating a configuration required for data transmission, and information for indicating configuration information generated by the second node for data transmission.

In various embodiments of the disclosure, in the method performed by the third node, the information for indicating a QoS parameter can be satisfied and/or a transmission configuration adopted and/or configuration information of data adopted by the second node within a time window includes information of at least one time window or information of a time window.

In accordance with another aspect of the disclosure, a first node is provided. The first node includes a transceiver for transmitting and receiving a signal, and at least one processor coupled with the transceiver and configured to perform the method performed by the first node as described above.

In accordance with another aspect of the disclosure, a second node is provided. The second node includes a transceiver configured to transmit and receive a signal, and at least one processor coupled with the transceiver and configured to perform the method performed by the second node as described above.

In accordance with another aspect of the disclosure, a third node is provided. The third node includes a transceiver configured to transmit and receive a signal, and at least one processor coupled with the transceiver and configured to perform the method performed by the third node as described above.

In accordance with another aspect of the disclosure, one or more non-transitory computer-readable medium having stored thereon instructions is provided. The instructions, when executed by at least one processor, cause the at least one processor to perform the method performed by the first node and/or the second node and/or the third node as described above.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a system architecture of system architecture evolution (SAE) according to an embodiment of the disclosure;

FIG. 2 illustrates a system architecture according to an embodiment of the disclosure;

FIG. 3A illustrates a flowchart of configuring traffic transmission according to an embodiment of the disclosure;

FIGS. 3B, 3C, 3D, 3E and 3F are various embodiments of a flowchart of FIG. 3A;

FIG. 4 illustrates traffic mapping modes according to an embodiment of the disclosure;

FIG. 5 illustrates a traffic configuration process according to an embodiment of the disclosure;

FIG. 6 illustrates a traffic configuration process according to an embodiment of the disclosure;

FIG. 7 illustrates a traffic configuration process according to an embodiment of the disclosure;

FIG. 8 illustrates a traffic configuration process according to an embodiment of the disclosure;

FIG. 9 illustrates a block diagram of a node according to an embodiment of the disclosure; and

FIG. 10 illustrates a block diagram of a user equipment according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

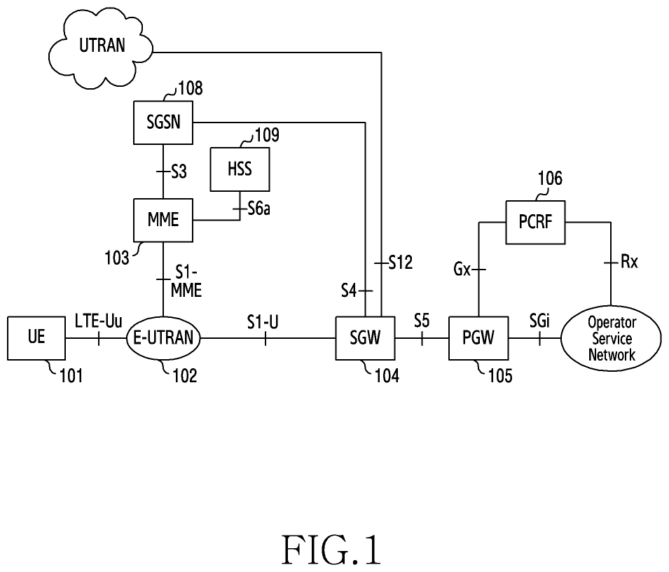

FIGS. 1, 2, 3A, 3B, 3C, 3D, 3E, 3F, 4, 5, 6, 7, 8, 9, and 10 discussed below and various embodiments for describing the principles of the disclosure in this patent document are only for illustration and should not be interpreted as limiting the scope of the disclosure in any way. Those skilled in the art will understand that the principles of the disclosure can be implemented in any suitably arranged system or device.

FIG. 1 illustrates a system architecture of system architecture evolution (SAE) according to an embodiment of the disclosure.

Referring to FIG. 1, user equipment (UE) 101 is a terminal device for receiving data.

An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, or the like, and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, or the like.

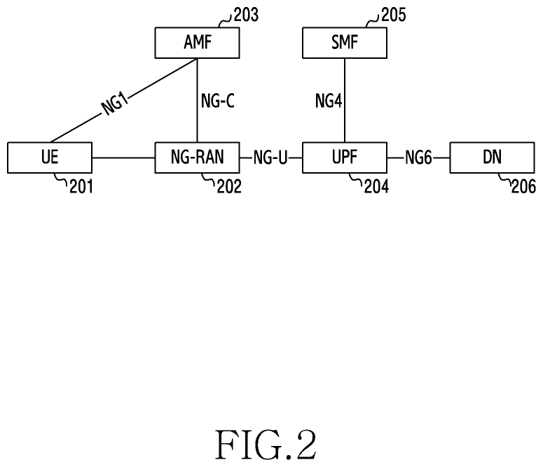

FIG. 2 illustrates a system architecture according to an embodiment of the disclosure.

Referring to FIG. 2, other embodiments of a system architecture 200 can be used without departing from the scope of the disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Embodiments of the disclosure are further described below with reference to the accompanying drawings.

The text and drawings are provided as examples only to help understand the disclosure. They should not be interpreted as limiting the scope of the disclosure in any way. Although certain embodiments and examples have been provided, based on the disclosure herein, it will be apparent to those skilled in the art that changes may be made to the illustrated embodiments and examples without departing from the scope of the disclosure.

In a communication network (such as, but not limited to, a 6G network), artificial intelligence technology will be widely used, resulting in a lot of data transmission to support the artificial intelligence technology, such as transmission of an artificial intelligence model, transmission of data used to train the model, and transmission of data during model training. A performance of the transmissions of data determines a performance gain or user experience obtained by application of the artificial intelligence technology in the network. Therefore, research on data transmission related to artificial intelligence has become an important direction in the research of communication network (such as, but not limited to, the 6G network). The disclosure aims to define a data transmission mechanism of the communication network (such as, but not limited to, the 6G network) according to features of traffic related to artificial intelligence. The above content is ˜rather than limiting. Those skilled in the art should understand that the data transmission mechanism of the disclosure can also be applied to data other than the data related to artificial intelligence without departing from the scope of the disclosure. The data transmission mechanism of the disclosure can also be applied to communication networks other than the 6G network without departing from the scope of the disclosure.

Before specific contents are introduced, some assumptions and some definitions of the disclosure are given below:
Message names in the disclosure are merely examples, and other message names may also be used;
Words such as “first” and “second”, or the like, included in the message names in the disclosure are merely used for distinguishing one message from another message, and do not denote an execution order;
In the disclosure, the detailed description of operations unrelated to the disclosure is omitted;
In the disclosure, the operations in each flow may be combined with each other for execution, or may be executed separately. The execution operations in each flow are merely exemplary, other possible execution operations and/or orders are not excluded;
In the disclosure, a base station may be a 6G base station or a 5G base station (such as a gNB, an ng-eNB), or may be a 4G base station (such as an eNB), or may be other types of access nodes;
In the disclosure, a time window is one or more time ranges, and the time window can be periodic or aperiodic. In an example, if the time window contains multiple time ranges, each time range may appear periodically or in an aperiodic manner, and a time length of each time range may be the same, or may be different; and
In the disclosure, traffic and data (and/or data packet) have equivalent meanings, and hereinafter, we use “traffic” and/or “data packet” for description. In an example, the traffic may be a radio bearer, or a data radio bearer (DRB).

Nodes involved in the disclosure include:
First node: this node may be a network node device or a user terminal device. When the node is a network node device, in an example, it can be a node of a core network, such as a node for mobility management (such as an AMF), a node for traffic management (such as a SMF), a node for user plane data transmission (such as a UPF), wherein the above-mentioned node can be a node of a 5G core network or a node of a 6G core network, in another example, it can be a node on an RAN side, such as a base station, a central unit of the base station, or a control plane portion of the central unit of the base station, a user plane portion of the central unit of the base station, and a distributed unit of the base station; and
Second node: a node different from the first node. This node may be a network node device or a user terminal device. When the node is a network node device, in an example, it can be a node of the core network, such as a node for mobility management (such as an AMF), a node for traffic management (such as a SMF), a node for user plane data transmission (such as a UPF), wherein above-mentioned node can be a node of the 5G core network or a node of the 6G core network, in another example, it can be a node on the RAN side, such as a base station, a central unit of the base station, a control plane portion of the central unit of the base station, a user plane portion of the central unit of the base station, a distributed unit of the base station.

The base stations involved in the above-mentioned nodes may be one of the following types (not excluding other types that may be used for user equipment to access):
Long term evolution (LTE) base station;
5G base station;
6G base station;
Non-terrestrial network (NTN) base station;
High altitude platform station (HAPS) base station;
Drone base station; and
WIFI access point.

In a communication network (such as, but not limited to, a 6G network), certain traffic (such as, but not limited to, traffic related to artificial intelligence) (referred to as artificial intelligence traffic, AI traffic in the disclosure) will become an important part of network data, and also presents different features from traditional service data (such as video, file transfer protocol (FTP), extended reality (XR), or the like). In order to better support transmission of certain traffic (such as artificial intelligence traffic), it is necessary to analyse their features and configure data transmission based on these new features. Therefore, how to configure the transmission of traffic in the network has become an urgent issue to be addressed in the research of communication networks (such as, but not limited to, 6G).

After analysis, certain traffic (such as artificial intelligence traffic) shows nature of time window, that is, in different time windows, their data transmission requirements (such as, but not limited to, QoS requirements) will be different. In order to better help the network side to allocate resources for the transmission of traffic (such as artificial intelligence traffic), the disclosure proposes a configuration method based on time window, which configures an adaptive transmission mechanism for data transmission in different time windows, thereby saving network resources while ensuring data transmission requirements. Furthermore, in various embodiments of the disclosure, the disclosure proposes a configuration method based on time window, which configures an adaptive transmission mechanism for data transmission in different time windows, thereby saving network resources while ensuring the QoS requirements of data.

The messages that appear and the operations involved in the above methods are given below. The serial numbers of the following operations do not represent the order in which the steps are executed, and the following operations can be executed individually or in combination with each other.

In the disclosure, the “QoS parameters of a traffic” of data transmission requirements (for example, the QoS requirements of data) may include at least one of the following parameters:
QoS priority level;
Packet delay budget;
Packet error rate;
5G QoS identifier value;
Delay critical;
Averaging window;
Maximum data burst volume;
Allocation and retention priority;
Guaranteed bit rate (GBR) QoS flow information, such as maximum flow bit rate uplink/downlink, guaranteed flow bit rate uplink/downlink, maximum packet loss rate uplink/downlink; and
Reflective QoS attribute.

Those skilled in the art should understand that parameters included in the above “QoS parameters of a traffic” are only examples, and other parameters may also be included without departing from the scope of the disclosure. The QoS-related information in the disclosure is information related to the aforementioned QoS parameters.

In the disclosure, the traffic may be uplink traffic or downlink traffic, or may include both the uplink traffic and the downlink traffic.

The method for configuring artificial intelligence traffic transmission proposed by the disclosure can also be applied to other types of traffic. In the following description, traffic is used as an abbreviation of artificial intelligence traffic to illustrate the method proposed by the disclosure.

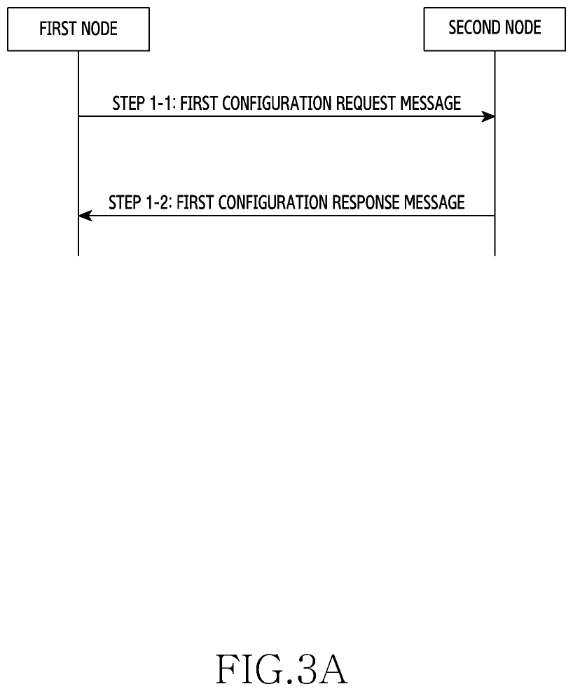

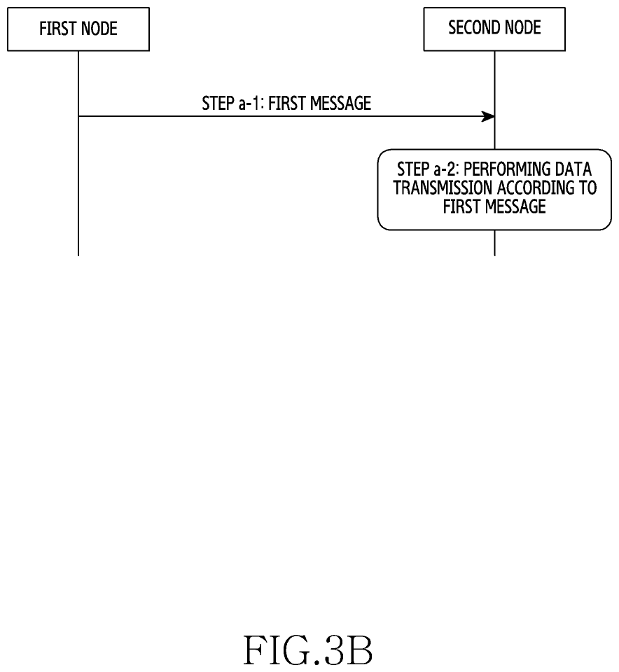

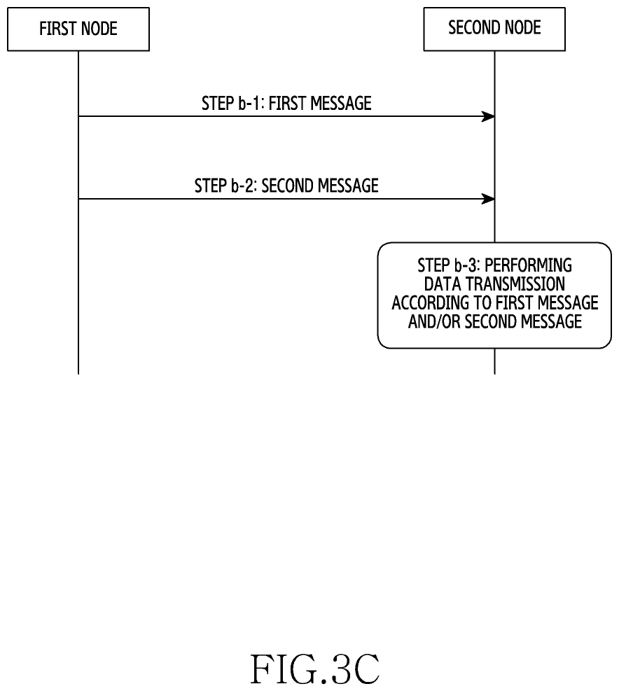

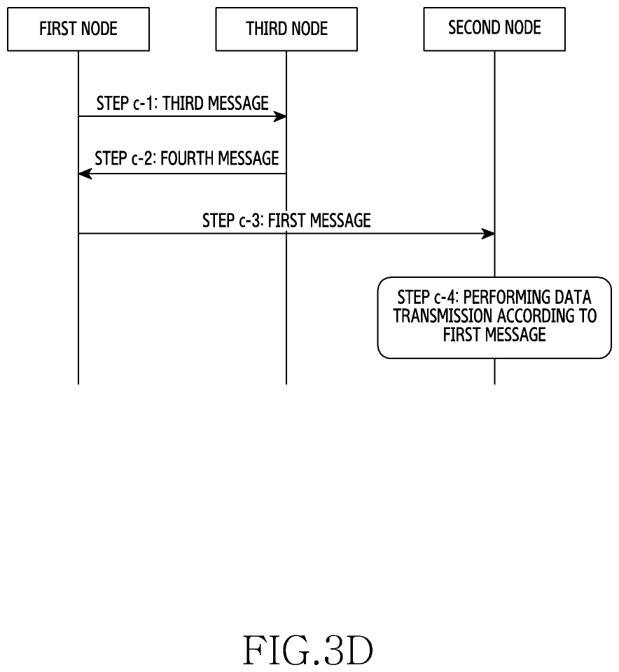

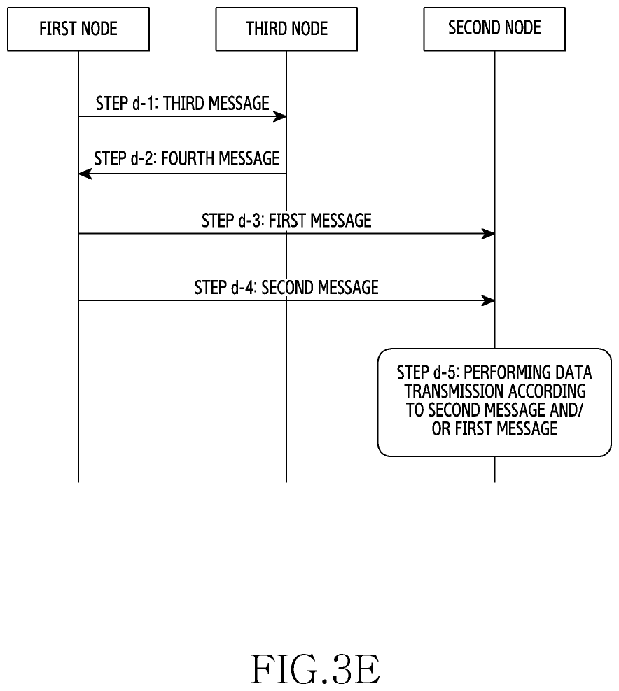

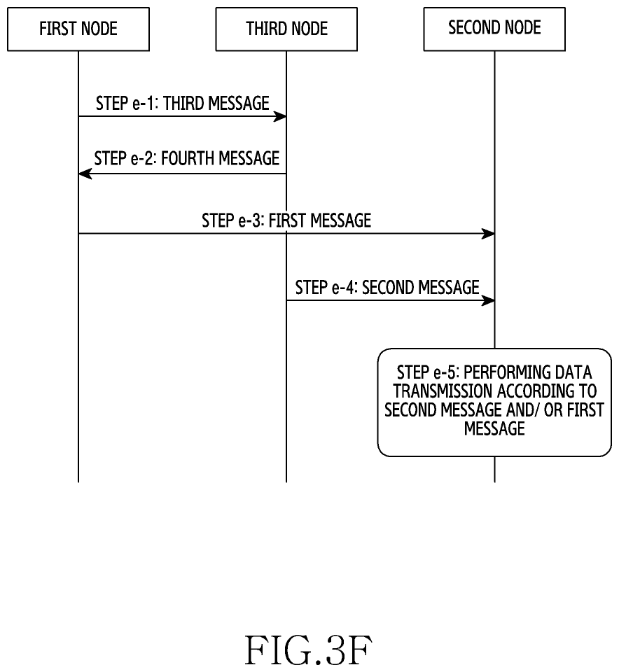

FIG. 3A illustrates a flowchart of configuring traffic transmission according to an embodiment of the disclosure.

FIGS. 3B, 3C, 3D, 3E and 3F are various embodiments of a flowchart of FIG. 3A according to various embodiments of the disclosure.

Referring to FIG. 3A, in order to configure the transmission of the traffic, interaction in the following process will be performed between the first node and the second node, as shown in FIG. 3A.

Operation 1-1: the first node sends a first message to the second node. In various embodiments of the disclosure, the first message may include time information related to data. The first message will be used by the second node to configure transmission of traffic, or will be used by the second node to perform the transmission of traffic. In various embodiments of the disclosure, the first message may be a first configuration request message, and a function of this message is to transmit information related to the traffic to the second node, thereby helping the second node configure resources required for transmitting the traffic or generate configuration information required for transmitting the traffic. In an example, the first message includes information of traffic in one or more time windows, and the information of traffic may be different for different time windows. For one traffic (such as uplink traffic, or downlink traffic, or uplink and downlink traffic), the first configuration request message includes at least one of the following information:
Identity information of data, which indicates a type of data, such as a traffic ID, a flow ID, a protocol data unit (PDU) session ID, a QoS flow ID, a bearer ID, a data radio bearer ID, a radio link control (RLC) bearer ID, a PDU set ID, or the like;
Time information related to data, which indicates the features and/or configuration, or the like, of traffic in different time windows. A beneficial effect of the information is to help the second node obtain different features of the traffic at different times, and then can help the second node to configure the transmission of traffic, or to perform data transmission according to the features at different times. For a time window, the information includes at least one of:
First time window information, which indicates the time window and information related to the time window. The information includes at least one of:
First identity information of the time window. In an example, the information indicates the time window. In another example, the information indicates a configuration corresponding to the time window (such as at least one of the following “First QoS information of a traffic”, “first transmission configuration information” and “First configuration information of the traffic”);
First start point information of the time window, which indicates a start position of the time window, such as an absolute time (e.g., including year, month, week, day, hour, minute, second, millisecond, microsecond, or the like), a frame number, a subframe number, a slot number, a symbol number, or may be a relative time, such as a time offset relative to a reference time (such as a time length, a number of frames, a number of subframes, a number of slots, a number of symbols, or the like);
First length information of the time window, which indicates a time length of the time window, in units such as year, month, week, day, hour, minute, second, millisecond, microsecond, frame, subframe, slot, symbol, or the like;
First end point information of the time window, which indicates an end position of the time window, such as an absolute time (e.g., including year, month, week, day, hour, minute, second, millisecond, microsecond, or the like), a frame number, a subframe number, a slot number, a symbol number, or may be a relative time, such as a time offset relative to a reference time (such as a time length, a number of frames, a number of subframes, a number of slots, a number of symbols, or the like);
First information of amount of data, which indicates an amount of data that needs to be and/or has been transmitted within the time window. The information includes at least one of:
Information of a total amount of data. In an example, the information indicates the total amount of data that needs to be transmitted within a time window. A beneficial effect of the information is to help the second node know the total amount of data that needs to be transmitted, so that the second node may perform reasonable resource allocation based on this information, thereby improve resource utilization efficiency;
Information of the amount of data that has been transmitted. In an example, the information indicates the amount of data that has been transmitted within a time window. A beneficial effect of this information is to help the second node know the amount of data that still needs to be transmitted, so as to perform reasonable resource allocation and improve resource utilization efficiency. For example, in a handover process of the user equipment, the first node is a serving node of a source cell, and the second node is a serving node of a target cell, and the second node will determine the amount of data that still needs to be transmitted by the second node for the user equipment based on this information, and then determine the resource allocation of the second node; and
Information of an amount of remaining data. In an example, the information indicates the amount of data that still needs to be transmitted within a time window. A beneficial effect of this information is to help the second node know the amount of data that still needs to be transmitted, so as to perform reasonable resource allocation and improve resource utilization efficiency. For example, in the handover process of the user equipment, the first node is a serving node of a source cell, and the second node is a serving node of a target cell, and the second node will determine the amount of data that still needs to be transmitted by the second node for the user equipment based on this information, and then determine the resource allocation of the second node;
First offset information to start the time window, which indicates offset required to start the time window;
First cycle information of the time window, which indicates a cycle by which the time window appears. When the time window needs to be repeated periodically, this information indicates the cycle that it repeatedly appears;
First information of number of the time window, which indicates the number of times the time window needs to appear, such as the number of times the time window appears;
First indication information for continued use of a configuration, which indicates whether the second node can continue to use the configuration information corresponding to the time window after the time window ends;
First time window delay time information, which indicates a time length that the second node is allowed to continue traffic transmission according to the configuration corresponding to the time window after the time window ends. After receiving the information, the second node can start a timer after the time window ends, and an initial value of the timer is set to time indicated by the information. Before the timer expires, the second node may continue to use the configuration corresponding to the time window for data transmission. After the timer expires, the second node may no longer use the configuration corresponding to the time window;
First data amount threshold information, which indicates an amount of data that the second node is allowed to continue traffic transmission according to the configuration corresponding to the time window after the time window ends. After receiving this information, if the amount of data remaining in the time window or the amount of data that the second node continues to transmit after the time window ends is less than the threshold, the second node can continue to use the configuration corresponding to the time window for data transmission after the time window ends, otherwise, the second node may no longer use the configuration corresponding to the time window; and
First timer length information, which indicates a length of a timer related to the time window. In an example, the information indicates the length of the time window. After the time window starts, the timer starts. When the timer expires, the time window ends. In another example, the information indicates how long to elapse before starting the time window, when the timer expires, the time window starts;
First QoS information of a traffic, which indicates a setting of QoS parameters applicable to the traffic within the time window indicated by the above “first time window information”. If the “time information related to data” includes “first QoS information of the traffic” and “first time window information”, an effect that can be achieved is that the traffic has different QoS information in different time windows. A beneficial effect of this information is to help the second node generate the configuration of the traffic of a specified time window. The information includes at least one of:
First information of a QoS parameter, which gives a setting of each QoS parameter applicable to the traffic indicated by the above “identity information of data”, for the specific QoS parameters, please refer to the description of “QoS parameters of a traffic” above;
First information of an optional QoS parameter, which gives information of one or more optional QoS parameters applicable to the traffic indicated by the above “identity information of data”, and a function of this information is to notify the second node of its optional QoS parameters when meeting a traffic transmission requirement. In an example, if the second node cannot meet a requirement of the QoS parameter indicated by the above-mentioned “first information of the QoS parameter”, it may select a set of QoS parameters indicated in the “first information of the optional QoS parameter” to satisfy. A beneficial effect of this information is to help the second node satisfy the traffic transmission as much as possible, avoid rejecting the traffic when a set of QoS parameters cannot be satisfied, and ensure continuity of user traffic transmission. This information may include information of one or more sets of QoS parameters; and
First identity information of a QoS parameter, such as a QoS parameter index. The information may be used to indicate the information of a set of (at least one) QoS parameters in the above “first information of a QoS parameter” and “first information of an optional QoS parameter”;
First configuration request information, which indicates a configuration related to traffic requested by the first node. The configuration may be different configurations in different time windows. The information may help the second node allocate resources required for serving traffic within a time window, and/or generate configurations required for serving traffic within a time window, and/or perform traffic transmission according to the information. In an example, for a time window, the “first configuration request information” is in one-to-one correspondence with the above “first time window information”. A beneficial effect thereof is that the second node can allocate different resources according to different time windows, which can effectively save network resources or resources of terminal devices and improve resource utilization efficiency. Another beneficial effect is that different configurations can be used for data transmission in different time windows according to the information, thereby ensuring the QoS of data in different time windows. The information may include configuration information of one or more time windows. For a time window, the information includes at least one of:
Configuration identity information, which indicates a set of configurations corresponding to a time window. The set of configurations may be configurations included in the “first configuration request information”;
First transmission configuration information, which indicates a configuration required to transfer (such as receive and/or transmit) the traffic. The transmission configuration includes such as address information and/or other information (such as but not limited to transmission configuration, tunnel endpoint information, or the like). In an example, the information indicates address information on a first node side, and in another example, the information indicates address information on any other node side. If the “first configuration request information” includes “first transmission configuration information” and “first time window information”, an effect that can be achieved is that the traffic uses different address information in different time windows. A beneficial effect of this information is that different addresses are used for data transmission and reception at different times, thereby effectively allocating resources for data transmission and reception. The information includes at least one of:
First transmission configuration identity information, such as a transmission configuration ID;
Transport layer address information, such as an Internet Protocol (IP) address; and
Identity information of a tunnel endpoint, such as a tunnel endpoint ID; and
First configuration information of the traffic, which indicates a configuration required when configuring traffic transmission. The configuration will have different configurations based on different types of the second node. If the “first configuration request information” includes “first configuration information of the traffic” and “first time window information”, an effect that can be achieved is that the traffic uses different configuration information in different time windows for data transmission. A beneficial effect of this information is to help the second node obtain the configuration required for traffic transmission, and also can help the second node generate the configuration required for traffic transmission, and effectively configure resources required for data transmission. The information includes at least one of:
First identity information of the configuration, such as a configuration ID. The information is used to identify a set of configurations;
First information of a serving cell, which indicates one or more cells serving the traffic. In an example, when the information is used in combination with the above “first time window information”, the “first information of a serving cell” is for the time window indicated by the “first time window information”, when there are multiple time windows, different time windows have different “first information of a serving cell”. A beneficial effect of this information is that the second node can select different cells or cell groups for data transmission in different time windows, ensuring the QoS requirements of the traffic and avoiding unnecessary waste of resources. The information includes at least one of:
Identity information of a serving cell, which identifies identities of one or more cells serving the traffic, such as a cell ID, a cell index, a NR cell global identifier (NCGI), an E-UTRAN cell global identifier (ECGI), a physical cell identity (PCI). The cell can be a primary cell (for example, a primary cell, a special cell, a primary SCG cell, or a secondary cell);
Indication information of a serving cell group, which indicates one or more cell groups serving the traffic, such as a master cell group (MCG), and a secondary cell group (SCG); and
Identity information of the serving cell group, which indicates identities of one or more cell groups serving the traffic, such as a cell group ID; and
First bearer configuration information, which is configuration information required to configure the second node for data and/or traffic transmission. In an example, when the information is used in combination with the above “first time window information”, the “first bearer configuration information” is for the time window indicated by the “first time window information”. Different time windows have different “first bearer configuration information” when there are multiple time windows. A beneficial effect of this information is that the second node can select different bearer configurations for data transmission in different time windows, ensuring the QoS requirements of the traffic and avoiding unnecessary waste of resources. The information includes at least one of:
Identity information of a bearer;
Configuration of a PDCP layer. When different time windows have different configurations of the PDCP layer, the information indicates a configuration of a time window. Further, the configuration information may also include time window information (see the description in the above “first time window information”);
Configuration of an RLC layer. When different time windows have different configurations of the RLC layer, the information indicates the configuration of a time window. Further, the configuration information may also include the time window information (see the description in the above “first time window information”);
Configuration of a logical channel. When different time windows have different logical channel configurations (for example, different time windows have different logical channel priorities), the information indicates the configuration of a time window. Further, the configuration information can also include the time window information (see the description in the above “first time window information”);
Configuration of a cell group, such as a cell group configuration. When there are different configurations of the cell group for different time windows, the information indicates the configuration of a time window. Further, the configuration information may also include the time window information (see the description in the above “first time window information”);
Configuration of a bearer, such as a radio bearer configuration. When different time windows have different configurations of the bearer, the information indicates the configuration of a time window. Further, the configuration information may also include the time window information (see the description in the above “first time window information”); and
Configuration of an RLC bearer, such as an RLC bearer configuration. When there are different configurations of the RLC bearer for different time windows, the information indicates the configuration of a time window. Furthermore, the configuration information may also include the time window information (see the description in the above “first time window information”).

Among the configuration information included in the above “first bearer configuration information”, only part of the configuration information (of such as a PDCP, an RLC, a logical channel, a cell group, a bearer, an RLC bearer, or the like) may be related to the time window.
First transceiving configuration information, which indicates configuration information required for receiving and/or transmitting the traffic. In an example, the information indicates DRX configuration information. In an example, when this information is used in combination with the above “first time window information”, the “first transceiving configuration information” is for the time window indicated by the “first time window information”. Different time windows have different “first transceiving configuration information” when there are multiple time windows. A beneficial effect of this information is to indicate the user equipment to use different DRX configurations in different time windows, thereby saving energy of the user equipment. The information includes at least one of:
Cycle information, such as a DRX cycle, a short DRX cycle, a long DRX cycle;
Counter and/or counter information, such as a short cycle timer/counter;
Offset information, such as a start offset; and
Timer information, such as an inactivity timer, a retransmission timer, an uplink/downlink HARQ round-trip time timer (UL/DL HARQ RTT timer), or the like.

Among the configuration information included in the above “first transceiving configuration information”, only part of the configuration information (of such as the period, the counter, the offset, the timer, or the like) may be related to the time window. When the second node receives the above “first transceiving configuration information”, it will select the configuration in the “first transceiving configuration information” corresponding to the time window according to the current time window to transmit and receive data, for example, select corresponding parameters to calculate an active time of the DRX.
Configuration indication information. A purpose of this information is to indicate the configuration (for example, of a bearer) used by the second node when transmitting data and/or traffic. In an example, when the first node does not transmit time window information to the second node, the first node can use the “configuration indication information” to dynamically indicate the configuration used by the second node for data transmission. For example, at a start of a time window, the first node will transmit the indication information to the second node, which is used for indicating the configuration used for traffic transmission within the time window. After the time window ends, the first node will transmit the indication information to the second node again, which is used for indicating the configuration used for traffic transmission in a next time window. A beneficial effect of this information is to help the second node dynamically select an appropriate configuration for traffic transmission, improve resource utilization efficiency, and meet the QoS requirements of the traffic. The information includes at least one of:
Configuration identity information, which indicates a configuration needs to be used by the second node;
Second identity information of a time window, which indicates a time window, or indicates a configuration corresponding to the time window. For the configuration of the time window indicated by this information, please refer to the above “time information related to data”, or for the indicated configuration, please refer to the configuration indicated in the above “first configuration request information”;
Second identity information of a QoS parameter, which indicates a QoS parameter needs to be used by the second node. For details of the QoS parameter indicated by this information, please refer to the above “First QoS information of a traffic”;
Second transmission configuration identity information, which indicates a transmission configuration needs to be used by the second node. For details of the transmission configuration indicated by this information, please refer to the above “first transmission configuration information”;
Second identity information of configuration of a traffic, which indicates a configuration needs to be adopted by the second node. In an example, this information may be the above “first identity information of the configuration”. For a detailed description of a configuration indicated by this information, please refer to the above “first configuration information of the traffic”;
Activation indication information, which is used for indicating a configuration that needs to be activated. In an example, the information may be identity information of a bearer, that is, a configuration of the bearer indicated by the information is to be activated. In another example, the information may be identity information of a logical channel, that is, configuration information corresponding to the logical channel indicated by the information is to be activated. In another example, the information may be identity information of a cell, that is, the cell indicated is to be activated. In an example, the information may be identity information of the transmission configuration (such as the above “first transmission configuration identity information”), that is, configuration information (see the above “first transmission configuration information”) of the transmission configuration indicated by the information is to be activated. In another example, the information may be identity information of the configuration information of the traffic (such as the above “first identity information of the configuration”), that is, configuration information (see the above “first configuration information of the traffic”) of the traffic indicated by the information is to be activated; and
Deactivation (deactivation) indication information or suspend indication information, which is used for indicating a configuration that needs to be deactivated or suspended. In an example, the information may be identity information of a bearer, that is, a configuration of the bearer indicated by the information is to be deactivated or suspended. In another example, the information may be identity information of a logical channel, that is, configuration information corresponding to the logical channel indicated by the information is to be deactivated or suspended. In another example, the information may be identity information of a cell, that is, the cell indicated is to be deactivated or suspended. In an example, the information may be identity information of the transmission configuration (such as the above “first transmission configuration identity information”), that is, configuration information (see the above “first transmission configuration information”) of the transmission configuration indicated by this information is to be deactivated or suspended. In another example, the information may be identity information of the configuration information of the traffic (such as the above “first identity information of the configuration”), that is, configuration information (see the above “first configuration information of the traffic”) of the traffic indicated by this information is to be deactivated or suspended.

In another example, the “configuration indication information” may also be used for indicating configurations indicated by at least two of the above “first QoS information of the traffic”, “first transmission configuration information” and “first configuration information of the traffic”.

In another example, the first node may indicate the configuration needs to be adopted by the second node in a form of a bitmap, and each bit represents at least one configuration among the above “first QoS information of the traffic”, “first transmission configuration information” and “first configuration information of the traffic”.

In another example, the “time information related to data” and “configuration indication information” in the above-mentioned first message may be sent in two different messages:
First data association information, which is used for indicating traffics associated with the traffic indicated by the above “identity information of data”. In an example, these associated traffics may be data transmitted within different time windows. In an implementation, the information may be identity information of one or more traffics associated with the traffic indicated by the above “identity information of data”. In another example, the information indicates one identity information of associated traffics, and all traffics with the same “first data association information” may be considered as being associated with each other; and
First traffic mapping request information, which indicates a mapping relationship of the traffic requested by the first node, that is, a mapping from an input traffic to an output traffic. Possible types of the input traffic are: a PDU session, a QoS flow, a DRB, and possible types of the output traffic are: a DRB, an RLC bearer, or the like. These types are merely examples, other possible traffic types are not excluded. In an example, the information indicates mapping information from a QoS flow to a DRB. In another example, the information indicates mapping information from a DRB to an RLC bearer. In order to configure the mapping information, in an example, it may be indicated through a configuration of a service data adaptation protocol (SDAP), in another example, it may be indicated through a configuration of a PDCP, and in another example, it may be indicated through a configuration of another protocol layer. In an implementation, when this information is used in combination with the above-mentioned “time information related to data”, the “first traffic mapping information” is for the time window indicated by the “time information related to data”. When there are multiple time windows, different time windows have different “first traffic mapping information”. After receiving the information, the second node will map the traffic according to the mapping relationship indicated by the information, and generate corresponding configuration and resource allocation. A beneficial effect of this information is that the second node can allocate resources for the traffic according to different mapping modes, so as to ensure the QoS of the traffic in different time windows. The information includes at least one of:
Mapping mode indication information, which indicates a mapping mode of the traffic. Each mapping mode indicates a mapping from an input traffic to an output traffic. The information may be explicit information. A beneficial effect of this information is to help the second node to determine how to allocate resources for the input traffic to meet its QoS requirements, and at the same time, it can also help the second node to perform effective resource allocation and improve resource utilization efficiency. The information may indicate one of the following modes:
Time window-based mapping. This mode is applicable to a situation where the input traffic has different QoS requirements in different time windows. In this mode, one input traffic will be mapped to different output traffics, and each traffic only has data transmission in one time window;
Traffic-based mapping. In this mode, even if the input traffic has different QoS parameters in different time windows, one input traffic will only be mapped to one output traffic;
One-to-one mapping: this mode is to map one input traffic to one output traffic. In an example, when an input traffic has different QoS requirements in different time windows, the output traffic will also have different QoS requirements in different time windows; and
One-to-multiple mapping: this mode is to map one input traffic to multiple output traffics. In an example, when an input traffic has different QoS requirements in different time windows, the multiple output traffics will respectively correspond to one of the different time windows of the input traffic.

In another example, the above-mentioned mapping mode may also be notified to the second node in an implicit manner: in an implementation, the above “first configuration request information” includes information of multiple time windows, in another implementation, the above “first configuration request information” includes different configurations for different time windows (such as different “first transmission configuration information”, different “first configuration information of the traffic”):
Identity information of the input traffic;
Time window indication information of the input traffic, which indicates one or more time window information of the input traffic. For content contained in this information, please refer to the description of the above “time information related to data”;
Identity information of the output traffic;
Indication information of a default output traffic, which indicates whether to map the input traffic to the default output traffic;
Time window information, which indicates a time window to which the above-mentioned first traffic mapping information is applicable. For details, please refer to the description of the above “time information related to data”;
First applicable information, which indicates an applicable time range of the above “first configuration request information”, such as a start time, an end time, time length information, or the like. After configuring this information, the second node will only execute the configuration in the above “first configuration request information” within the time range indicated by the “first applicable information”; and
First QoS request information, which indicates QoS parameters that the first node requests the second node to satisfy. The information contains a request for one or more sets of QoS parameters. For a set of QoS parameters, please refer to the description in the above “QoS parameters of the traffic” for details. Optionally, the information may also include identity information of the set of QoS parameters, such as a QoS parameter index. When the second node receives multiple sets of QoS parameters, in an example, the second node needs to select a set of QoS parameters therein for resource allocation, and determine whether the selected QoS parameters can be satisfied, in another example, the second node needs to determine whether the multiple sets of QoS parameters can be satisfied, and perform resource allocation for the multiple sets of QoS parameters. Further, in this example, the multiple sets of QoS parameters indicate the QoS that needs to be satisfied in different time periods (but the second node does not know the time window information corresponding to each set of QoS information). A beneficial effect of this information is to help the second node to determine the QoS requirements it needs to meet, so as to determine whether there are enough resources to meet these QoS requirements. In a further example, the information also indicates, the QoS parameters requested to be satisfied either outside the time range indicated by the above “first configuration request information” or outside the time range indicated by the “first applicable information”, or when the second node does not receive the above “first configuration request information”.

Operation 1-2: optionally, the second node sends a second message to the first node. In various embodiments of the disclosure, the second message may be a first configuration response message. The second node determines a configuration required for traffic transmission according to the configuration and/or the information related to the traffic in the first configuration request message, and transmits the configuration information generated at the second node to the first node. Further, the second node also allocates resources for the transmission of the traffic. For a traffic, the first configuration response message includes at least one of the following information:
Identity information of data, which indicates a type of data, such as a traffic ID, a flow ID, a PDU session ID, a QoS flow ID, a bearer ID, a data radio bearer ID, an RLC bearer ID, a PDU set ID, or the like;
First configuration response information, which indicates QoS parameters can be satisfied, and/or transmission configuration adopted, and/or configuration information of the traffic adopted by the second node in different time windows. A beneficial effect of this information is to help the first node to know the configuration adopted by the second node when transmitting the traffic, determine its resource allocation during the traffic transmission, and can also help the first node to determine whether to transmit the traffic, to reduce unnecessary waste of resources. For a time window, the information includes at least one of:
Second time window information, which indicates information of a time window that can meet the QoS requirements, such as identity information of one or more time windows. A beneficial effect of this information is to help the first node determine the QoS that the second node can satisfy, determine whether to transmit traffic and/or resource allocation. Further, when the time window determined by the second node is different from the time window transmitted by the first node in the first configuration request message, this information may also be used for indicating information of a new time window. A beneficial effect of this information is to help the first node determine the time window for traffic transmission, and notify other entities or application servers of the information, so as to adjust the time window for traffic transmission and ensure the QoS requirements of the traffic. For what is contained in this information, please refer to the above “first time window information”;
Second QoS information of the traffic, which indicates QoS parameters that the second node can satisfy. This information may contain identity information of one or more QoS parameters to indicate the QoS parameters it can satisfy;
Second transmission configuration information, which indicates a configuration required to transfer (such as receive and/or transmit) the traffic. The transmission configuration includes, such as address information and/or other information (such as, but not limited to, a transmission configuration, tunnel endpoint information, or the like). In an example, the information indicates address information on a second node side. In another example, the information indicates address information on another node side. If the “first time configuration response information” includes “second transmission configuration information” and “second time window information”, an effect that can be achieved is that the traffic uses different address information in different time windows. A beneficial effect of this information is that different addresses are used for data reception and transmission at different times, thereby effectively allocating resources for data transmission and reception. The information includes at least one of:
Second transmission configuration identity information, such as a transmission configuration ID;
Transport layer address information, such as an IP address; and
Identity information of a tunnel endpoint, such as a tunnel endpoint ID;
Second configuration information of the traffic, which indicates configuration information generated by the second node for transmitting the traffic. If the “first time configuration response information” includes “second configuration information of the traffic” and “second time window information”, an effect that can be achieved is that the traffic uses different configuration information in different time windows. A beneficial effect of this information is to help the first node to configure the user equipment to use different configurations for data transmission in different time windows, so as to effectively utilize network resources and avoid waste of resources. The information includes at least one of:
Second identity information of a configuration, such as a configuration ID. The information is used for identifying a set of configurations;
Second information of a serving cell, referring to the description in the above “first information of a serving cell”. In an example, the information can also be used in combination with time window information (see the description of the above “second time window information”), representing that there is different serving cell information in different time windows;
Second bearer configuration information, referring to the description in the above “first bearer configuration information”. In an example, the information can also be used in combination with time window information (see the description of the above “second time window information”), representing that there is different bearer configuration information in different time windows; and
Second transceiving configuration information, referring to the description in the above “first transceiving configuration information”. In an example, the information can also be used in combination with time window information (see the description of the above “second time window information”), representing that there are different transceiving configuration information in different time windows;
First traffic mapping response information, which indicates a traffic mapping mode adopted by the second node. For details, please refer to the description in the above “first traffic mapping request information”; and
First QoS response information, which indicates QoS parameters that the second node can satisfy, such as identity information of one or more QoS parameters. After receiving the information, the first node can determine whether to allow the second node to transmit the traffic. A beneficial effect of this information is to indicate acceptable QoS parameters of the second node, thereby helping the first node to determine whether to allow the second node to serve the traffic and avoiding unnecessary waste of resources.

Through the above two operations, the transmission configuration of the traffic will be different according to the different time windows. On the one hand, the traffic can be transmitted using different configurations in different time windows to meet the QoS requirements of the traffic in different time periods. On the other hand, the network side reasonably allocates appropriate resources according to the QoS requirements of different time windows of the traffic, reducing the waste of resources. There are two possible modes to configure the traffic transmission implemented by the above process:
Mode 1: semi-static configuration, that is, the first node configures the configurations of different time windows to the second node, and then the second node can adopt different configurations in different time windows; and
Mode 2: dynamic configuration (such as a dynamic indication according to the “configuration indication information” in operation 1-1), that is, the first node dynamically configures the second node to transmit traffic. For example, at a start of a time window, the first node configures the second node to use the configuration corresponding to the time window for data transmission.

Optionally, before operation 1-1, there may also be an operation 1-0: the first node acquires time information related to the data. In various embodiments of the disclosure, based on the “time information related to data”, the first node sends the first message to the second node, and the acquired “time information related to data” may come from other entities (if the first node is a base station or a central unit of the base station, or a control plane portion of the central unit of the base station, then the “time information related to data” comes from a configuration of a core network entity. If the first node is a distributed unit of the base station, the “time information related to data” is from the central unit of the base station, or the control plane portion of the central unit of the base station, or a user plane portion of the central unit of the base station. If the first node is the user plane portion of the central unit of the base station, the “time information related to data” is from the control plane portion of the central unit of the base station, or a user plane entity of the core network, such as a UPF). For content of the “time information related to data”, please refer to the content in the above operation 1-1. In addition, the first node can also acquire configuration information related to traffic transmission in operation 1-0. For content of the “configuration information related to traffic transmission”, please refer to at least one of the “first data association information”, “first traffic mapping request information”, “first applicable information”, and “first QoS request information” in the above operation 1-1.

In a practical system, the above process has several embodiments as follows:
Embodiment 1: the first node configures at least one configuration information for the second node, and the second node decides a configuration for data transmission by itself based on the at least one configuration information, such as using different configurations for data transmission in different time windows.

Referring to FIG. 3B, this embodiment includes the following operations:

Operation a-1: the first node sends a first message to the second node, wherein the message includes at least one of the following information (for content of the specific information in the message, please refer to the description in the above operation 1-1):
Identity information of data;
Time information related to data;
First data association information;
First traffic mapping request information;
First applicable information; and
First QoS request information.

Operation a-2: based on the information contained in the received first message, the second node selects an appropriate configuration for data transmission for a type of data indicated by the identity information of data. For example, within a time window, the configuration for the time window (such as the first transmission configuration information, the first configuration information of the traffic, or the like) is selected for data transmission.

In the above example, the first node may be a base station or a central unit of the base station or a control plane portion of the central unit of the base station or a user plane portion of the central unit of the base station, and the second node is a user terminal device, or the first node is the central unit of the base station or the control plane portion of the central unit of the base station or the user plane portion of the central unit of the base station, and the second node is a distributed unit of the base station, or the first node is the control plane portion of the central unit of the base station, and the second node is the user plane portion of the central unit of the base station. The above-mentioned first node and second node are just examples, and other possible nodes are not excluded.

A technical effect of the above embodiment is that: the second node can perform data transmission based on different configurations of different time windows, which guarantees the QoS of data transmission, and saves resources.
Embodiment 2: the first node configures at least one configuration information for the second node, and then the first node dynamically indicates a transmission configuration of the data.

Referring to FIG. 3C, this embodiment includes the following operations:

Operation b-1: the first node sends a first message to the second node, wherein the message includes at least one of the following information (for content of the specific information in the message, please refer to the description in the above operation 1-1):
Identity information of data;
Data association information;
Time information related to data;
First traffic mapping request information;
First applicable information; and
First QoS request information.

Operation b-2: the first node sends a second message to the second node, wherein the message is used for indicating a configuration required by the second node to perform data transmission. This message may indicate transmission of different data. For a type of data (such as the data indicated by one “identity information of data”), the information includes at least one of (for content of the specific information in the message, please refer to the description in the above operation 1-1):
Configuration identity information;
Second identity information of a time window;
Second identity information of a QoS parameter;
Second transmission configuration identity information;
Second identity information of a configuration of a traffic;
Activation indication information; and
Deactivation indication information or suspend indication information.

Operation b-3: the second node transmits data according to the configuration indicated by the second message (and/or the first message).

In the above example, the first node may be a base station or a central unit of the base station or a control plane portion of the central unit of the base station or a user plane portion of the central unit of the base station, and the second node is a user terminal device, or the first node is the central unit of the base station or the control plane portion of the central unit of the base station or the user plane portion of the central unit of the base station, and the second node is a distributed unit of the base station, or the first node is the control plane portion of the central unit of the base station, and the second node is the user plane portion of the central unit of the base station. The above-mentioned first node and second node are just examples, and other possible nodes are not excluded.

A technical effect of the above embodiment is that: the second node can dynamically adjust the configuration required for data transmission based on at least one pre-configured configuration information (information in the first message) and dynamic indication information (information in the second message) to ensure the QoS of data transmission, and save resources.
Embodiment 3: the first node obtains a configuration of data transmission from the third node, and then configures the second node. The second node decides the configuration of data transmission by itself based on the configuration information, such as using different configurations for data transmission in different time windows.

Referring to FIG. 3D, this embodiment includes the following operations:

Operation c-1: the first node sends a third message to the third node, wherein the message includes at least one of the following information (for content of the specific information in the message, please refer to the description in the above operation 1-1):
Identity information of data;
Time information related to data;
First data association information;
First traffic mapping request information;
First applicable information; and
First QoS request information.

Operation c-2: the third node sends a response message (a fourth message) for the third message to the first node, wherein the message includes at least one of the following information (for content of the message, please refer to the description in the above operation 1-2):
Identity information of data;
First configuration response information;
Second traffic mapping response information; and
First QoS response information.

Operation c-3: the first node sends the first message to the second node, wherein the message includes at least one of the following information (for content of the message, please refer to the description in the above operation 1-1):
Identity information of data;
Time information related to data;
Second data association information, referring to the above “first data association information”;
Second traffic mapping information, referring to the above “first traffic mapping information”;
Second applicable information, referring to the above “first applicable information”; and
Second QoS request information, referring to the above “first QoS request information”.

Operation c-4: based on the information contained in the received first message, the second node selects an appropriate configuration for data transmission for a type of data indicated by the identity information of data. For example, within a time window, the configuration for the time window (such as the first transmission configuration information, the first configuration information of the traffic, or the like) is selected for data transmission.

In the above example, the first node may be a base station or a central unit of the base station or a control plane portion of the central unit of the base station or a user plane portion of the central unit of the base station, the second node is a user terminal device, and the third node is a distributed unit of the base station. The above-mentioned first node, second node and third node are just examples, and other possible nodes are not excluded.

A technical effect of the above embodiment is that: the third node can allocate resources based on the time information of the traffic (such as the information contained in the third message), thereby saving the resources of the third node, meanwhile, the first node will configure the second node (such as the first message) based on the configuration generated by the third node (such as the information in the fourth message), the second node can perform data transmission based on different configurations of different time windows, ensuring the QoS of data transmission and saving resources.
Embodiment 4: the first node obtains a configuration of data transmission from the third node, and then configures the second node. The second node decides the configuration of data transmission according to the indication information transmitted by the first node, such as using different configurations for data transmission in different time windows.

Referring to FIG. 3E, his embodiment includes the following operations:

Operation d-1: the first node sends a third message to the third node, wherein the message includes at least one of the following information (for content of the specific information in the message, please refer to the description in the above operation 1-1):
Identity information of data;
Time information related to data;
First data association information;
First traffic mapping request information;
First applicable information; and
First QoS request information.

Operation d-2: the third node sends a response message (a fourth message) for the third message to the first node, wherein the message includes at least one of the following information (for content of the message, please refer to the description in the above operation 1-2):
Identity information of data;
First configuration response information;
First traffic mapping response information; and
First QoS response information.

Operation d-3: the first node sends a first message to the second node, wherein the message includes at least one of the following information (for content of the message, please refer to the description in the above operation 1-1):
Identity information of data;
Data association information;
Time information related to data;
Second traffic mapping information, referring to the above “first traffic mapping information”;
Second applicable information, referring to the above “first applicable information”; and
Second QoS request information, referring to the above “first QoS request information”;

Operation d-4: the first node sends a second message to the second node, wherein the message is used for indicating a configuration required by the second node for data transmission. This message may indicate transmission of different data. For a type of data (such as the data indicated by the “identity information of data”), the information includes at least one of the following information (for content of the specific information in the message, please refer to the description in the above operation 1-1):
Configuration identity information;
Second identity information of a time window;
Second identity information of a QoS parameter;
Second transmission configuration identity information;
Second identity information of a configuration of a traffic;
Activation indication information; and
Deactivation indication information or suspend indication information.

Operation d-5: the second node transmits data according to the configuration indicated by the second message (and/or the first message).

In the above example, the first node may be a base station or a central unit of the base station or a control plane portion of the central unit of the base station or a user plane portion of the central unit of the base station, the second node is a user terminal device, and the third node is a distributed unit of the base station. The above-mentioned first node, second node and third node are just examples, and other possible nodes are not excluded.

A technical effect of the above embodiment is that: the third node can allocate resources based on the time information of the traffic (such as the information contained in the third message), thereby saving the resources of the third node, meanwhile, the second node can dynamically adjust the configuration required for data transmission based on at least one pre-configured configuration information (information in the first message) and dynamic indication information (information in the second message) to ensure the QoS of data transmission, and save resources.
Embodiment 5: the first node obtains a configuration of data transmission from the third node, and then configures the second node. The second node decides the configuration of data transmission according to the indication information transmitted by the third node, such as using different configurations for data transmission in different time windows.

Referring to FIG. 3F, this embodiment includes the following operations:

Operation e-1: the first node sends a third message to the third node, wherein the message includes at least one of the following information (for content of the specific information in the message, please refer to the description in the above operation 1-1):
Identity information of data;
Time information related to data;
First data association information;
First traffic mapping request information;
First applicable information; and
First QoS request information.

Operation e-2: the third node sends a response message (a fourth message) for the third message to the first node, wherein the message includes at least one of the following information (for content of the message, please refer to the description in the above operation 1-2):
Identity information of data;
First time configuration response information;
First traffic mapping response information; and
First QoS response information.

Operation e-3: the first node sends a first message to the second node, wherein the message includes at least one of the following information (for content of the message, please refer to the description in the above operation 1-1):
Identity information of data;
Time information related to data;
Second data association information, referring to the above “first data association information”;
Second configuration request information, referring to the above “first configuration request information”;
Second data traffic mapping information, referring to the above “first traffic mapping information”;
Second applicable information, referring to the above “first applicable information”; and
Second QoS request information, referring to the above “first QoS request information.”

Operation e-4: the third node sends a second message to the second node, wherein the message is used for indicating a configuration required by the second node for data transmission. This message may indicate transmission of different data. For a type of data (such as the data indicated by the “identity information of data”), the information includes at least one of (for content of the specific information in the message, please refer to the description in the above operation 1-1):
Configuration identity information;
Second identity information of a time window;
Second identity information of a QoS parameter;
Second transmission configuration identity information;
Second identity information of a configuration of a traffic;
Activation indication information; and
Deactivation indication information or suspend indication information.

Operation e-5: the second node transmits data according to the configuration indicated by the second message (and/or the first message).

In the above example, the first node may be a base station or a central unit of the base station or a control plane portion of the central unit of the base station or a user plane portion of the central unit of the base station, the second node is a user terminal device, and the third node is a distributed unit of the base station. The above-mentioned first node, second node and third node are just examples, and other possible nodes are not excluded.

A technical effect of the above embodiment is that: the third node can allocate resources based on the time information of the traffic (such as the information contained in the third message), thereby saving the resources of the third node, meanwhile, the second node can dynamically adjust the configuration required for data transmission based on at least one pre-configured configuration information (information in the first message) and dynamic indication information (information in the second message) to ensure the QoS of data transmission, and save resources.

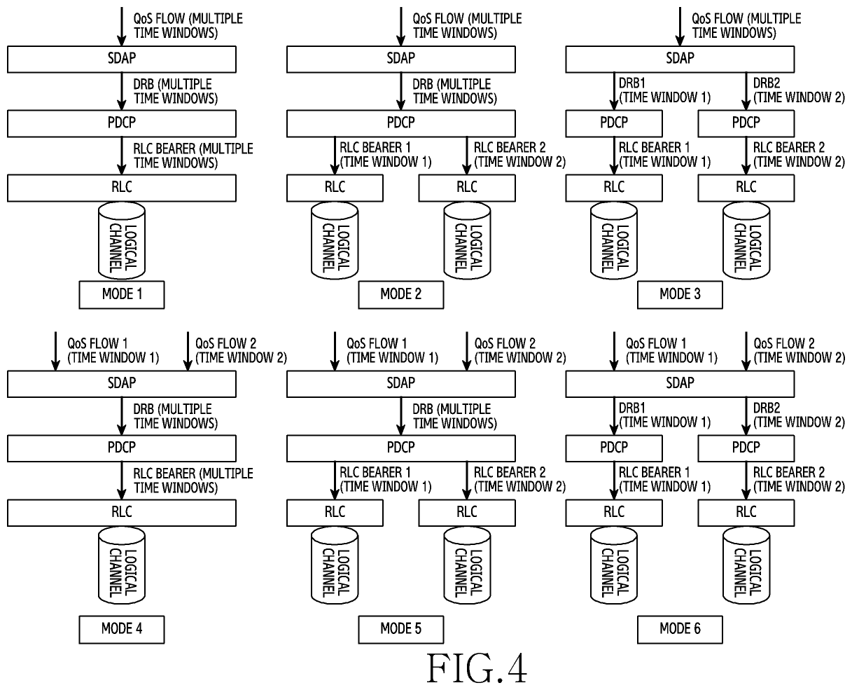

FIG. 4 illustrates traffic mapping modes according to an embodiment of the disclosure.

Referring to FIG. 4, when the traffic is transmitted on an air interface, it will be mapped into a configuration of the air interface for transmission, and the configuration can be indicated by a bearer (or other names), such as a data radio bearer (DRB), an RLC bearer. In the following illustration, for convenience, the traffic is defined as a QoS flow, but in an actual system, the traffic may also be indicated by other names. A mapping of the QoS flow to the bearer can be performed at a user terminal (such as a mapping of uplink data), or at a network side (such as a base station, a central unit of the base station, a user plane portion of the central unit of the base station, a distributed unit of the base station) (such as a mapping of downlink data). In the disclosure, the mapping of the QoS flow to the bearer may have different modes (in the following illustration, a time window can be one time period or multiple time periods), as shown in FIG. 4:
Mode 1: one QoS flow with different QoS parameters in different time windows is mapped into one DRB, and one DRB is mapped into one RLC bearer. In this mode, one QoS flow has different QoS parameters in different time windows, and one DRB also has different QoS parameters in different time windows, and the DRB is mapped into an RLC bearer. When configuring transmission of the DRB on the air interface, the DRB will perform transmission based on different configurations for different time windows.
Mode 2: one QoS flow with different QoS parameters in different time windows is mapped into one DRB, and one DRB is mapped into different RLC bearers. In this mode, one QoS flow has different QoS parameters in different time windows, and one DRB also has different QoS parameters in different time windows, and the DRB is mapped into different RLC bearers (such as RLC bearer 1 and RLC bearer 2). When configuring the transmission of the DRB on the air interface, the DRB will perform transmission based on configurations of different RLC bearers for different time windows.
Mode 3: one QoS flow with different QoS parameters in different time windows is mapped into at least one DRB, and one DRB is mapped into one RLC bearer. In this mode, one QoS flow will be mapped into different DRBs in different time windows (for example, mapped into DRB1 in time window 1, and mapped into DRB2 in time window 2). When configuring the transmission of different DRBs on the air interface, different DRBs will perform transmission based on different configurations.
Mode 4: traffics with different QoS parameters in different time windows are mapped into different QoS flows, at least one QoS flow is mapped into one DRB, and one DRB is mapped into one RLC bearer. In this mode, one QoS flow is only transmitted within one time window, and different QoS flows have different QoS parameters. At least one QoS flow (for example, QoS flow 1 and QoS flow 2) will be mapped into one DRB. When configuring the transmission of the DRB on the air interface, the DRB will perform transmission according to the configuration of the RLC bearer, but will perform transmission based on different configurations in different time windows.
Mode 5: traffics with different QoS parameters in different time windows are mapped into different QoS flows, at least one QoS flow is mapped into one DRB, and one DRB is mapped into at least one RLC bearer (for example, RLC bearer 1 and RLC bearer 2). In this mode, one QoS flow is only transmitted within one time window, and different QoS flows have different QoS parameters. At least one QoS flow (for example, QoS flow 1 and QoS flow 2) will be mapped into one DRB. When configuring the transmission of the DRB on the air interface, the DRB will perform transmission according to the configurations of different RLC bearers, and each RLC bearer will only perform transmission within one time window.
Mode 6: traffics with different QoS parameters in different time windows are mapped into different QoS flows, one QoS flow is mapped into one DRB, and one DRB is mapped into one RLC bearer. In this mode, one QoS flow is only transmitted within one time window, and different QoS flows have different QoS parameters. One QoS flow is mapped into one DRB, and different QoS flows (such as QoS flow 1 and QoS flow 2) are mapped into different DRBs (such as DRB1 and DRB2). DRB1 is mapped into RLC bearer 1, and DRB2 is mapped into RLC bearer 2. In this way, when configuring the transmissions of different DRBs on the air interface, different DRBs will perform transmission based on the configurations of different RLC bearers, and only perform transmission within one time window.

In the above process, the first node and the second node can be the following possible combinations (in the following introduction, for the information contained in the first message and the second message, please refer to the description of the above first configuration request message and first configuration response message, respectively). For different combinations, there will be different embodiments:

### Embodiment A

First node: a core network entity, such as an AMF, second node: a base station, or a central unit of the base station, or a control plane portion of the central unit of the base station, or a user plane portion of the central unit of the base station.

Operation A-1: the first node sends a first message to the second node. For a type of traffic, the first message includes at least one of the following information:
Identity information of data, such as a traffic ID, a flow ID, a PDU session ID, a QoS flow ID, a bearer ID, a data radio bearer ID, an RLC bearer ID, a PDU set ID, or the like;
Time information related to data. What is contained in this information will be different according to the above-mentioned different mapping modes:
Embodiment 1: the information includes information of at least one time window. For a time window, the information includes one of: first time window information, first QoS information of a traffic, first transmission configuration information (this information indicates information on a user plane entity side (such as UPF) of the core network). In an example, this embodiment is for mode 1/mode 2/mode 3;
Embodiment 2: the information includes information of a time window. The time window is a time window corresponding to a traffic. The information includes one of: first time window information, first QoS information of a traffic, and first transmission configuration information (this information indicates the information on a user plane entity side (such as UPF) of the core network). In an example, this embodiment is for mode 4/mode 5/mode 6;
First data association information;
First traffic mapping request information;
First applicable information;
First QoS request information; and
Configuration indication information.

Operation A-2: optionally, the second node sends a second message to the first node. For a traffic, the second message includes at least one of the following information:
Identity information of data, such as a traffic ID, a flow ID, a PDU session ID, a QoS flow ID, a bearer ID, a data radio bearer ID, an RLC bearer ID, a PDU set ID, or the like;
First configuration response information. What is contained in the information will be different according to the above-mentioned different mapping modes:
Embodiment 1: the information includes information of at least one time window. For a time window, the information includes one of: second time window information, second QoS information of a traffic, and second transmission configuration information (this information indicates information on a side of a base station, or a central unit of the base station, or a user plane of the central unit of the base station). In an example, this embodiment is for mode 1/mode 2/mode 3; and
Embodiment 2: the information includes information of a time window. The time window is a time window corresponding to traffic. The information includes one of: second time window information, second QoS information of a traffic, and second transmission configuration information (the information indicates information on a side of a base station, or a central unit of the base station, or a user plane of the central unit of the base station). In an example, this embodiment is for mode 4/mode 5/mode 6.

Through the above operations, the second node obtains the configuration information of the traffic (such as configuration information based on different time windows), and it will continue to configure other entities in the network (such as the distributed unit of the base station, the user plane portion of the central unit of the base station, the user equipment), and thereby adopt different configurations in different time windows to perform data transmission for the user equipment. In an example, when the second node is a base station, it can exchange the information of the traffic of the user equipment with other base stations according to the following “embodiment C” (the second node is equivalent to the first node in “embodiment C”, the “other base station” is equivalent to the second node in “embodiment C”), in an example, when the second node is a central unit of the base station, it can exchange the information of the traffic of the user equipment with a distributed unit of the base station according to the following “embodiment B” (the second node is equivalent to the first node in “embodiment B”), in an example, when the second node is a control plane portion of the central unit of the base station, it can exchange the information of the traffic of the user equipment with a user plane portion of the central unit of the base station according to the following “embodiment D” (the second node is equivalent to the first node in “embodiment D”), in an example, when the first node is a base station or a central unit of the base station or a control plane portion of the central unit of the base station, it can configure the transmission of the traffic of the user equipment according to the following “embodiment E”.

In the above process, for mode 1/2/3, each traffic (such as a QoS flow) will correspond to at least one QoS information, and each QoS information corresponds to a time window. For mode 4/5/6, each traffic (such as a QoS flow) will correspond to one QoS information, and this QoS information is only valid within one time window.

The above-mentioned first message may be a PDU session resource setup/modification request message, or an initial UE context setup request message, or a UE context modification request message on an interface between the core network and the base station. The above second message may be a PDU session resource setup/modification response message, or an initial UE context setup response message, or a UE context modification response message on the interface between the core network and the base station. The above-mentioned first message and second message may also be other types of messages.

### Embodiment B

First node: a central unit of a base station, or a control plane portion of the central unit of the base station, or a user plane portion of the central unit of the base station, second node: a distributed unit of the base station.

Operation B-1: the first node sends a first message to the second node. For a type of traffic, the first message includes at least one of the following information:
Identity information of data, such as a traffic ID, a flow ID, a PDU session ID, a QoS flow ID, a bearer ID, a data radio bearer ID, an RLC bearer ID, a PDU set ID, or the like;
Time information related to data. What is contained in this information will be different according to the above-mentioned different mapping modes:
Embodiment 1: the information includes information of at least one time window. For a time window, the information includes one of: first time window information, first QoS information of a traffic, and first transmission configuration information (this information indicates information on a side of the central unit of the base station or on a side of the user plane of the central unit of the base station). In an example, this embodiment is for mode 1/2/4/5;
Embodiment 2: the information includes information of a time window. The information includes one of: first time window information, first QoS information of a traffic, and first transmission configuration information (this information indicates the information on a side of the central unit of the base station or on a side of the user plane of the central unit of the base station). In an example, this embodiment is for mode 3/6;
First data association information;
First traffic mapping request information;
First applicable information;
First QoS request information; and
Configuration indication information.

Operation B-2: optionally, the second node sends a second message to the first node. For a type of traffic, the second message includes at least one of the following information:
Identity information of data, such as a traffic ID, a flow ID, a PDU session ID, a QoS flow ID, a bearer ID, a data radio bearer ID, an RLC bearer ID, a PDU set ID, or the like;
First configuration response information. What is contained in the information will be different according to the above-mentioned different mapping modes:
Embodiment 1: the information includes information of at least one time window. For a time window, the information includes one of: second time window information, second QoS information of a traffic, second transmission configuration information (this information indicates information on a side of the distributed unit of the base station), and second configuration information of the traffic. In an example, this embodiment is for mode 1/2/4/5; and
Embodiment 2: the information includes information of a time window. The time window is a time window corresponding to traffic. The information includes one of: second time window information, second QoS information of a traffic, second transmission configuration information (this information indicates information on a side of the distributed unit of the base station), and second configuration information of the traffic. In an example, this embodiment is for mode 3/6.

After the configuration is completed according to the above process, the distributed unit of the base station will transmit data packets received from the central unit of the base station or the user plane portion of the central unit of the base station to the user terminal device through the air interface. According to different ways of receiving data and different mapping relationships, the distributed unit of the base station has different behavior as follows:
Behavior 1: the data packets received by the distributed unit of the base station from a tunnel (an endpoint of the tunnel is on the side of the distributed unit of the base station) or an IP address (the IP address is on the side of the distributed unit of the base station) have different QoS parameters in different time windows, or information in the data packets indicates that different data packets have different QoS parameters. When these data packets are mapped to different RLC entities (e.g., data packets belonging to different time windows are mapped to different RLC entities), the distributed unit will hand them over to a corresponding RLC entity for processing according to the time window to which the data packets belong, when these data packets are mapped to different logical channels (e.g., data packets belonging to different time windows are mapped to different logical channels), the distributed unit will hand them over to a corresponding logical channel for processing according to the time window to which the data packets belong, when these data packets are served by different cells or cell groups (e.g., data packets belonging to different time windows are served by different cells or cell groups), the distributed unit will hand them over to a corresponding cell or cell group for processing according to the time window to which the data packets belong, and when these data packets are served by different configurations (such as a RLC configuration, a configuration of a logical channel, a cell group configuration CellGroupConfig) (e.g., data packets belonging to different time windows will be served by different configurations), the distributed unit will hand the data packets over to different configurations for transmission according to the time window to which the data packets belong;
Behavior 2: the data packets received by the distributed unit of the base station from a tunnel (an endpoint of the tunnel is on the side of the distributed unit of the base station) or an IP address (the IP address is on the side of the distributed unit of the base station) belong to only one time window, then the distributed unit will hand the received data packets over to a corresponding RLC entity for processing; and
Behavior 3: when the time window to which the data packets received by the distributed unit of the base station belong is different from a current time window, the distributed unit of the base station can carry out processing in one of the following modes:
Mode 1: discard the data packets; and
Mode 2: decide whether to discard the data packets according to the configuration. In an example, whether to discard the data packets is determined according to the above “first time window delay time information”. When the time window to which the data packets belong ends, the distributed unit can start a timer after the time window ends, and an initial value of the timer is set to time indicated by the “first time window delay time information”, before the timer expires, the distributed unit can continue to use the configuration corresponding to the time window for data transmission, after the timer expires, the distributed unit cannot use the configuration corresponding to the time window, and the data packets can be discarded. In an example, whether to discard the data packets is determined according to the above “first data amount threshold information”, if the amount of data remaining in the time window or the amount of data that the second node continues to transmit after the time window ends is less than the threshold, the second node can continue to use the configuration corresponding to the time window for data transmission. Otherwise, the second node cannot use the configuration corresponding to the time window, and the data packets can be discarded.

The above first message may be a UE context setup/modification request message on the interface between the central unit of the base station, or the control plane portion of the central unit of the base station, or the user plane portion of the central unit of the base station and the distributed unit of the base station, or a data packet on the user plane (such as a general packet radio service (GPRS) tunnelling protocol user plane (GTP-U) header of the data packet will contain the content in the above first message), the above second message may be a UE context setup/modification response message on the interface between the central unit of the base station, or the control plane portion of the central unit of the base station, or the user plane portion of the central unit of the base station and the distributed unit of the base station. The above-mentioned first message and second message may also be other types of messages.

### Embodiment C

First node: a source base station, or a central unit of the source base station, or a control plane portion of the central unit of the source base station, second node: a target base station, or a central unit of the target base station, or a control plane portion of the central unit of the target base station.

operation C-1: the first node sends a first message to the second node. For a type of traffic, the first message includes at least one of the following information:
Identity information of data, such as a traffic ID, a flow ID, a PDU session ID, a QoS flow ID, a bearer ID, a data radio bearer ID, an RLC bearer ID, a PDU set ID, or the like;
Time information related to data. What is contained in this information will be different according to the above-mentioned different mapping modes:
Embodiment 1: the information includes information of at least one time window. For a time window, the information includes one of: first time window information, first QoS information of a traffic, first transmission configuration information (this information indicates information on a side of the central unit of the base station or on a side of the user plane of the central unit of the base station), and first configuration information of the traffic; and
Embodiment 2: the information includes information of a time window. The information includes one of: first time window information, first QoS information of a traffic, first transmission configuration information (this information indicates the information on a side of the central unit of the base station or on a side of the user plane of the central unit of the base station), and first configuration information of the traffic;
First data association information;
First traffic mapping request information;
First applicable information;
First QoS request information; and
Configuration indication information.

Operation C-2: optionally, the second node sends a second message to the first node. For a type of traffic, the second message includes at least one of the following information:
Identity information of data, such as a traffic ID, a flow ID, a PDU session ID, a QoS flow ID, a bearer ID, a data radio bearer ID, an RLC bearer ID, a PDU set ID, or the like; and
First configuration response information. What is contained in the information will be provided in the following two possible embodiments:
Embodiment 1: the information includes information of at least one time window. For a time window, the information includes one of: second time window information, second QoS information of a traffic, second transmission configuration information (this information indicates information on a side of the distributed unit of the base station), and second configuration information of the traffic; and
Embodiment 2: the information includes information of a time window. The time window is a time window corresponding to traffic. The information includes one of: second time window information, second QoS information of a traffic, second transmission configuration information (this information indicates information on a side of the distributed unit of the base station), and second configuration information of the traffic.

After the configuration is completed according to the above process, the target base station, or the central unit of the target base station, or the control plane portion of the central unit of the target base station will determine its own behavior according to the received information. In an embodiment of the disclosure, the second node determines the amount of data needs to be transmitted within a time window according to the received “first data amount information” above, so as to determine resource allocation and configuration according to its own resource status.

The above first message may be a handover request message, or a data packet on the user plane (for example, the GPRS tunnelling protocol user plane (GTP-U) header of the data packet will contain the content in the above first message), the above second message may be a handover request acknowledge message. The above-mentioned first message and second message may also be other types of messages.

### Embodiment D

First node: a control plane portion of a central unit of a base station, second node: a user plane portion of the central unit of the base station.

Operation D-1: the first node sends a first message to the second node. For a type of traffic, the first message includes at least one of the following information:
Identity information of data, such as a traffic ID, a flow ID, a PDU session ID, a QoS flow ID, a bearer ID, a data radio bearer ID, an RLC bearer ID, a PDU set ID, or the like;
Time information related to data. What is contained in this information will be different according to the above-mentioned different mapping modes:
Embodiment 1: the information includes information of at least one time window. For a time window, the information includes one of: first time window information, first QoS information of a traffic, first transmission configuration information (this information indicates information on a side of the distributed unit of the base station), and first configuration information of the traffic;
Embodiment 2: the information includes information of a time window. The information includes one of: first time window information, first QoS information of a traffic, first transmission configuration information (this information indicates the information on a side of the distributed unit of the base station), and first configuration information of the traffic;
First data association information;
First traffic mapping request information;
First applicable information;
First QoS request information; and
Configuration indication information.

Operation D-2: optionally, the second node sends a second message to the first node. For a type of traffic, the second message includes at least one of the following information:
Identity information of data, such as a traffic ID, a flow ID, a PDU session ID, a QoS flow ID, a bearer ID, a data radio bearer ID, an RLC bearer ID, a PDU set ID, or the like;
First configuration response information. What is contained in the information will be provided in the following two possible embodiments:
Embodiment 1: the information includes information of at least one time window. For a time window, the information includes one of: second time window information, second QoS information of a traffic, second transmission configuration information (this information indicates information of the user plane portion of the central unit of the base station), and second configuration information of the traffic; and
Embodiment 2: the information includes information of a time window. The time window is a time window corresponding to a traffic. The information includes one of: second time window information, second QoS information of a traffic, second transmission configuration information (this information indicates information of the user plane portion of the central unit of the base station), and second configuration information of the traffic.

After the configuration is completed according to the above process, the user plane portion of the central unit of the base station (the second node) will determine its own behavior according to the received information. For example, the behaviors include:
Behavior 1: the second node performs mapping of traffics. According to the above different mapping modes, the mapping performed by the second node is as follows:
Mapping 1: corresponding to the above “mode 1”, in an embodiment of the disclosure, one QoS flow is mapped into one DRB, in another embodiment of the disclosure, the data of one DRB is transmitted to a tunnel endpoint or a destination IP address;
Mapping 2: corresponding to the above “mode 2”, in an embodiment of the disclosure, one QoS flow is mapped into one DRB, in an embodiment of the disclosure, the data of one DRB is transmitted to different tunnel endpoints or destination IP addresses according to different time windows, and each tunnel endpoint or IP address corresponds to data of one time window;
Mapping 3: corresponding to the above “mode 3”, in an embodiment of the disclosure, one QoS flow is mapped into different DRBs, and one DRB corresponds to one time window, in an embodiment of the disclosure, the data of one DRB is transmitted to a tunnel endpoint or a destination IP address;
Mapping 4: corresponding to the above “mode 4”, in an embodiment of the disclosure, different QoS flows are mapped into one DRB, and one DRB corresponds to multiple time windows, in an embodiment of the disclosure, the data of one DRB is transmitted to a tunnel endpoint or a destination IP address, or multiple tunnel endpoints or destination IP addresses (In this way, each tunnel endpoint or IP address corresponds to data of one time window);
Mapping 5: corresponding to the above “mode 5”, in an embodiment of the disclosure, different QoS flows are mapped into one DRB, and one DRB corresponds to multiple time windows, in an embodiment of the disclosure, the data of one DRB is transmitted to different tunnel endpoints or destination IP addresses according to different time windows, and each tunnel endpoint or IP address corresponds to data of one time window;
Mapping 6: corresponding to the above “mode 6”, in an embodiment of the disclosure, one QoS flow is mapped into one DRB, and one DRB corresponds to one time window, in an embodiment of the disclosure, the data of one DRB is transmitted to a tunnel endpoint or a destination IP address, and the tunnel endpoint or IP address corresponds to the data of one time window; and
Behavior 2: the second node transmits data or a data packet according to the configuration (herein, data and data packet can be used interchangeably), and adds additional information in the transmitted data packet to help the receiving node (such as the distributed unit of the base station) to acquire the information of the data packet, and the transmitted data packet may contain at least one of the following information:
QoS indication information, which indicates QoS information corresponding to the data packet. In an embodiment of the disclosure, the indicated QoS information is QoS information corresponding to a time window. After receiving the information, the receiving node (such as the distributed unit) can determine the configuration (such as an RLC configuration, a configuration of a logical channel, a cell group configuration cellgroupconfig, a configuration of an RLC bearer, a configuration of a bearer, a configuration of a serving cell, see the above description for details) required to process the data packet. A beneficial effect of this information is to help the receiving node adjust resources used to transmit data packet in a timely manner and improve resource utilization efficiency;
Indication information of a time window, which indicates a time window to which the data packet belongs. After receiving the information, the receiving node (such as the distributed unit) can determine the configuration (such as an RLC configuration, a configuration of a logical channel, a cell group configuration cellgroupconfig, a configuration of an RLC bearer, a configuration of a bearer, a configuration of a serving cell, see the above description for details) required to process the data packet according to the time window to which the data packet belongs. A beneficial effect of this information is to help the receiving node adjust the resources used to transmit data packets in a timely manner and improve resource utilization efficiency;
Indication information of a last data packet, which indicates whether the transmitted data packet is the last data packet. In an embodiment of the disclosure, the last data packet is a last data packet within one time window. After receiving the information, the receiving node can decide to stop or suspend the configuration corresponding to the time window (such as an RLC configuration, a configuration of a logical channel, a cell group configuration cellgroupconfig, a configuration of an RLC bearer, a configuration of a bearer, a configuration of a serving cell, see the above description for details) after the last packet has been transmitted. A beneficial effect of this information is to help the receiving node release resources in advance and improve resource utilization efficiency;
Configuration indication information, which indicates a configuration required to process the data packet. After receiving the information, the receiving node (such as the distributed unit) can determine the configuration required to process the data packet (such as an RLC configuration, a configuration of a logical channel, a cell group configuration cellgroupconfig, a configuration of an RLC bearer, a configuration of a bearer, a configuration of a serving cell, see the above description for details). A beneficial effect of this information is to help the receiving node to adjust resources used to transmit data packets in a timely manner and improve resource utilization efficiency;
Indication information for suspending a configuration, which indicates whether the configuration for data transmission needs to be suspended. In an embodiment of the disclosure, the configuration to be suspended may be a configuration corresponding to one time window. A beneficial effect of this information is to help the receiving node adjust resources used to transmit data packets in a timely manner and improve resource utilization efficiency;
Indication information for continued use of a configuration, which indicates whether to the configuration for data transmission needs to be used continuously. In an embodiment of the disclosure, if a time window has ended, the information indicates that the receiving node can still continue to use the configuration information corresponding to the time window for data transmission. A beneficial effect of this information is to help the receiving node adjust resources used to transmit data packets in a timely manner and improve resource utilization efficiency;
Time window start indication information, which indicates a start of a time window. A beneficial effect of this information is to help the receiving node (such as the distributed unit) adjust the configuration of data reception and transmission in a timely manner to ensure correct transmission of data;
Time window end indication information, which indicates an end of a time window. A beneficial effect of this information is to help the receiving node (such as the distributed unit) adjust the configuration of data reception and transmission in a timely manner to ensure correct transmission of data; and
Out-of-window configuration indication information, which indicates if there is still data within the time window that has not been transmitted after the time window ends, what configuration should be used for transmitting these data. In an example, the information indicates that the configuration corresponding to the time window to which the data packet belongs needs to be used for transmission, and in another example, the information indicates that the configuration corresponding to the current time window needs to be used for transmission. In another example, the configuration does not need to be sent to the receiving node, but the receiving node uses a default mode (this mode continues to use either the configuration corresponding to the time window to which the data packet belongs, or the configuration corresponding to the current time window) for data transmission. A beneficial effect of this information is to help the receiving node (such as the distributed unit) adjust the configuration of data reception and transmission in a timely manner to ensure correct transmission of data.

The information contained in the above data packet can help the receiving node (such as the distributed unit) determine the configuration of data transmission, and then adjust the resource allocation of data transmission in time to improve the resource utilization efficiency.

The above first message may be a bearer context setup/modification request message on the interface between the control plane portion of the central unit of the base station and the user plane portion of the central unit of the base station, the above second message may be a bearer context setup/modification response message on the interface between the control plane portion of the central unit of the base station and the user plane portion of the central unit of the base station. The above-mentioned first message and second message may also be other types of messages.

### Embodiment E

First node: a core network entity (such as an AMF), a base station, or a central unit of the base station, or a control plane portion of the central unit of the base station, or a distributed unit of the base station, second node: a user terminal device.

Operation E-1: the first node sends a first message to the second node. For a type of traffic, the first message includes at least one of the following information:
Identity information of data, such as a traffic ID, a flow ID, a PDU session ID, a QoS flow ID, a bearer ID, a data radio bearer ID, an RLC bearer ID, a PDU set ID, or the like;
Time information related to data. What is contained in this information will be different according to the above-mentioned different mapping modes:
Embodiment 1: the information includes information of at least one time window. For a time window, the information includes one of: first time window information, first QoS information of a traffic, and first configuration information of the traffic; and
Embodiment 2: the information includes information of a time window. The information includes one of: first time window information, first QoS information of a traffic, and first configuration information of the traffic;
First data association information;
First traffic mapping request information;
First applicable information;
First QoS request information; and
Configuration indication information.

Operation E-2: optionally, the second node sends a second message to the first node, and the second message is an acknowledge of the first message. In an embodiment of the disclosure, for a type of traffic, optionally, the second message further includes at least one of the following information:
Identity information of data, such as a traffic ID, a flow ID, a PDU session ID, a QoS flow ID, a bearer ID, a data radio bearer ID, an RLC bearer ID, a PDU set ID, or the like;
First configuration response information. What is contained in the information will be provided in the following two possible embodiments:
Embodiment 1: the information includes information of at least one time window. For a time window, the information includes one of: second time window information, second QoS information of a traffic, and second configuration information of the traffic; and
Embodiment 2: the information includes information of a time window. The time window is a time window corresponding to a traffic. The information includes one of: second time window information, second QoS information of the traffic, and second configuration information of the traffic.

In an embodiment of the disclosure, the second node transmits and receives data according to the configuration, in an example, the configuration includes configurations required for data transmission within one or more time windows, and after receiving the information, the second node may perform data transmission in different time windows according to corresponding configurations of data transmission. In an embodiment of the disclosure, the second node may determine the configuration used and/or data packet reception and/or transmission based on the information contained in the data packet transmitted by the first node, in an example, the second node dynamically changes the configuration required for data transmission according to the configuration of the first node, conversely, when the second node does not receive an indication from the first node, it does not change the configuration used for data transmission. In order to dynamically change the configuration used for data transmission, the information contained in the data packet transmitted by the first node to the second node may be at least one of (in an example, this information can be transmitted to the second node by way of a medium access control control element (MAC CE) or a PDCP header, a SDAP header, or an RLC header, or downlink control information (DCI)):
QoS indication information, which indicates QoS information corresponding to a data packet. In an embodiment of the disclosure, the indicated QoS information is QoS information corresponding to a time window. After receiving the information, the second node can determine the configuration (such as an RLC configuration, a configuration of a logical channel, a cell group configuration cellgroupconfig, a configuration of an RLC bearer, a configuration of a bearer, a configuration of a serving cell, see the above description for details) required to process the data packet. A beneficial effect of this information is to help the second node adjust the configuration used to transmit data packets in time, ensure correct data reception, and improve resource utilization efficiency;
Indication information of a time window, which indicates a time window to which the data packet belongs. After receiving the information, the second node can determine the configuration (such as an RLC configuration, a configuration of a logical channel, a cell group configuration cellgroupconfig, a configuration of an RLC bearer, a configuration of a bearer, a configuration of a serving cell, see the above description for details) required to process the data packet according to the time window to which the data packet belongs. A beneficial effect of this information is to help the second node adjust the configuration used to transmit data packets in time, and improve resource utilization efficiency;
Indication information of a last data packet, which indicates whether the transmitted data packet is the last data packet. In an embodiment of the disclosure, the last data packet is a last data packet within one time window. After receiving the information, the second node can decide to stop or suspend the configuration corresponding to the time window (such as an RLC configuration, a configuration of a logical channel, a cell group configuration cellgroupconfig, a configuration of an RLC bearer, a configuration of a bearer, a configuration of a serving cell, see the above description for details) after the last packet has been transmitted. A beneficial effect of this information is to help the second node release resources in advance and improve resource utilization efficiency;
Configuration indication information, which indicates a configuration required to process the data packet. After receiving the information, the second node can determine the configuration required to process the data packet (such as an RLC configuration, a configuration of a logical channel, cell group configuration cellgroupconfig, a configuration of an RLC bearer, a configuration of a bearer, a configuration of a serving cell, see the above description for details). A beneficial effect of this information is to help the second node adjust resources used to transmit data packets in a timely manner and improve resource utilization efficiency;
Indication information for suspending a configuration, which indicates whether the configuration for data transmission needs to be suspended. In an embodiment of the disclosure, the configuration to be suspended may be a configuration corresponding to one time window. A beneficial effect of this information is to help the second node adjust resources used to transmit data packets in a timely manner and improve resource utilization efficiency;
Indication information for continued use of a configuration, which indicates whether to the configuration for data transmission needs to be used continuously. In an embodiment of the disclosure, if a time window has ended, the information indicates that the second node can still continue to use the configuration information corresponding to the time window for data transmission. A beneficial effect of this information is to help the second node adjust resources used to transmit data packets in a timely manner and improve resource utilization efficiency;
Time window start indication information, which indicates a start of a time window. A beneficial effect of this information is to help the second node adjust the configuration of data reception and transmission in time to ensure correct transmission of data;
Time window end indication information, which indicates an end of a time window. A beneficial effect of this information is to help the second node adjust the configuration of data reception and transmission in time to ensure correct transmission of data; and
Out-of-window configuration indication information, which indicates if there is still data within the time window that has not been transmitted after the time window ends, what configuration should be used for transmitting these data. In an example, the information indicates that the configuration corresponding to the time window to which the data packet belongs needs to be used for transmission, and in another example, the information indicates that the configuration corresponding to the current time window needs to be used for transmission. In another example, the configuration does not need to be sent to the receiving node, but the receiving node uses a default mode (this mode continues to use either the configuration corresponding to the time window to which the data packet belongs, or the configuration corresponding to the current time window) for data transmission. A beneficial effect of this information is to help the second node adjust the configuration of data reception and transmission in time to ensure correct transmission of data.

The information contained in the above data packets can help the second node determine the configuration of data transmission, and then adjust the resource allocation of data transmission in time to improve the resource utilization efficiency.

The above first message may be a non-access stratum (NAS) message or an RRC reconfiguration message, or a MAC CE, or Downlink control information (DCI), or a PDCP header, or an RLC header on the interface between a core network entity (such as an AMF), or a base station, or a central unit of the base station, or a control plane portion of the central unit of the base station, or a distributed unit of the base station and the user terminal device, the above second message may be an RRC reconfiguration complete message. The above-mentioned first message and second message may also be other types of messages.

In order to complete the configuration of the transmission of the traffic of the user terminal, the foregoing embodiments A to E may be combined with each other. In an example, traffic transmitted by the user terminal have different QoS requirements in different time windows. Several possible examples are given below.

### Example 1 (Core Network Entity-Base Station-User Terminal (or User Equipment))

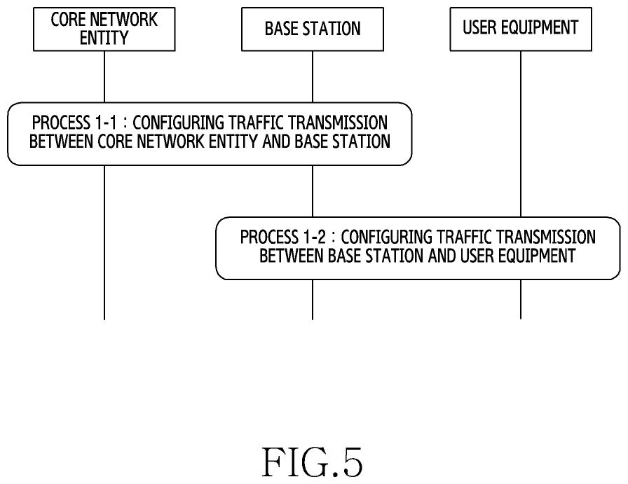

FIG. 5 illustrates a traffic configuration process according to an embodiment of the disclosure.

Referring to FIG. 5, the network entity serving the user terminal is a base station. In order to configure the transmission of traffic, this example includes the following processes:
Process 1-1: configuring traffic transmission between the core network entity and the base station, as in the above operations A-1 to A-2; and
Process 1-2: configuring traffic transmission between the base station and the user equipment, as in the above operations E-1 to E-2;

### Example 2 (Core Network Entity-Central Unit of Base Station-Distributed Unit of Base Station-User Terminal (or User Equipment))

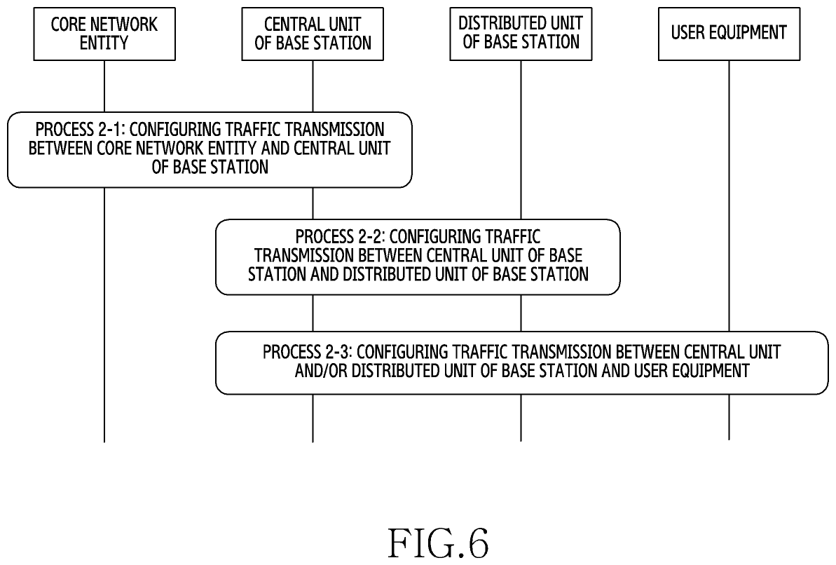

FIG. 6 illustrates a traffic configuration process according to an embodiment of the disclosure.

Referring to FIG. 6, in this example, after the central unit of the base station obtains the information of the user traffic, the distributed unit of the base station also needs to be configured. In order to configure the transmission of traffic, this example includes the following processes:
Process 2-1: configuring traffic transmission between the core network entity and the central unit of the base station, as in the above operations A-1 to A-2;
Process 2-2: configuring traffic transmission between the central unit of the base station and the distributed unit of the base station, as in the above operations B-1 to B-2; and
Process 2-3: configuring traffic transmission between the central unit of the base station and/or the distributed unit of the base station and the user equipment, as in the above operations E-1 to E-2;

Example 3 (Core Network Entity-Control Plane Portion of Central Unit of Base Station-User Plane Portion of Central Unit of Base Station-Distributed Unit of Base Station-User Terminal (or User Equipment))

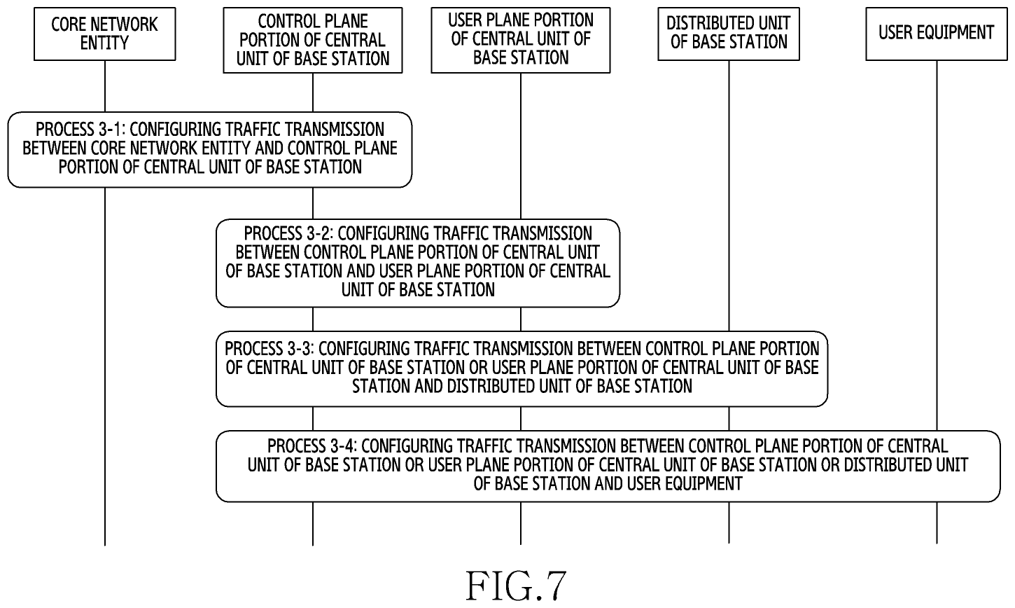

FIG. 7 a traffic configuration process according to an embodiment of the disclosure.

Referring to FIG. 7, in this example, after the control plane portion of the central unit of the base station obtains the information of the user traffic, the user plane portion of the central unit of the base station and the distributed unit of the base station need to be configured. In order to configure the transmission of traffic, this example includes the following processes:
Process 3-1: configuring traffic transmission between the core network entity and the control plane portion of the central unit of the base station, as in the above operations A-1 to A-2;
Process 3-2: configuring traffic transmission between the control plane portion of the central unit of the base station and the user plane portion of the central unit of base station, as in the above operations D-1 to D-2;
Process 3-3: configuring traffic transmission between the control plane portion of the central unit of the base station or the user plane portion of the central unit of base station and the distributed unit of the base station, as in the above operations B-1 to B-2; and
Process 3-4: configuring traffic transmission between the control plane portion of the central unit of the base station or the user plane portion of the central unit of base station or the distributed unit of the base station and the user equipment, as in the above operations E-1 to E-2; and

Example 4 (Source Base Station/Central Unit of Source Base Station/Control Plane Portion of Central Unit of Source Base Station-Target Base Station/Central Unit of Target Base Station/Control Plane Portion of Central Unit of Target Base Station-User Terminal (or User Equipment))

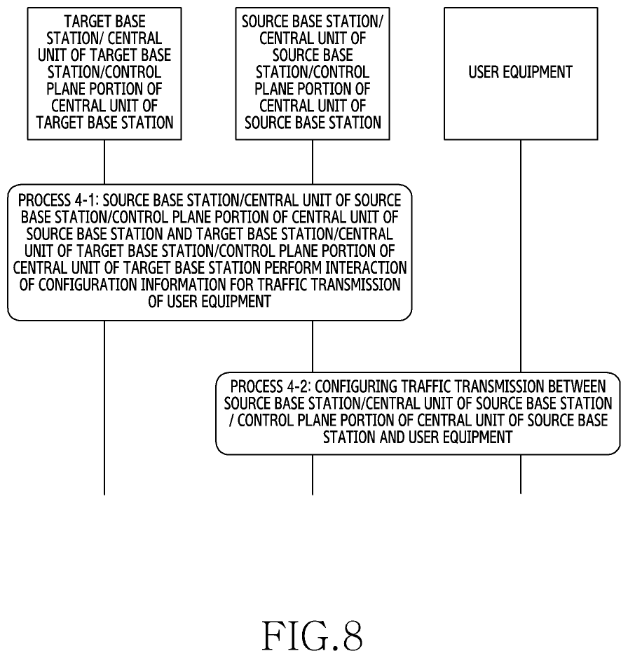

FIG. 8 illustrates a traffic configuration process according to an embodiment of the disclosure.

Referring to FIG. 8, in this example, the user equipment is handed over from one base station (or a cell) to another base station (or another cell), and the source base station needs to send configuration information related to the traffic of the user equipment to the target base station, in order to configure the transmission of the traffic of the user equipment at the target base station. This example includes the following processes:
Process 4-1: the source base station/the central unit of the source base station/the control plane portion of the central unit of the source base station and the target base station/the central unit of the target base station/the control plane portion of the central unit of the target base station perform interaction of configuration information for traffic transmission of the user equipment, as in the above operations C-1 to C-2; and
Process 4-2: configuring traffic transmission between the source base station/the central unit of the source base station/the control plane portion of the central unit of the source base station and the user equipment, as in the above operations E-1 to E-2.

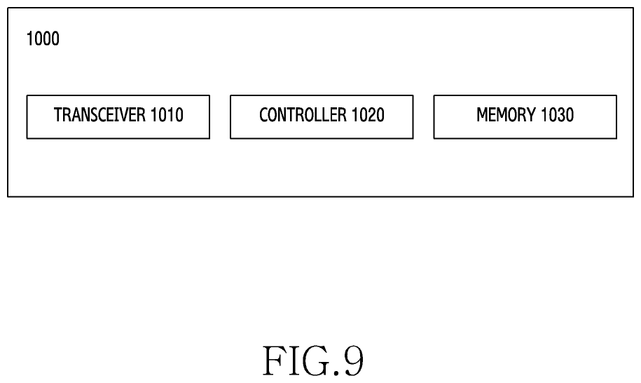

FIG. 9 illustrates a block diagram of a node according to an embodiment of the disclosure.

Here, a node is taken as an example to illustrate its structure and function. However, it should be understood that the structure and function shown can also be applied to a core network entity and a base station (or a central unit of the base station, or a control plane portion of the central unit of the base station, or a user plane portion of the central unit of the base station, or a distributed unit of the base station, or the like).

Referring to FIG. 9, a node 1000 includes a transceiver 1010, a controller 1020, and a memory 1030. Under the control of the controller 1020 (which may be implemented as one or more processors), the node 1000 (including the transceiver 1010 and the memory 1030) is configured to perform the operations of the node described herein. Although shown as separate entities, the transceiver 1010, the controller 1020, and the memory 1030 may be implemented as a single entity, such as a single chip. The transceiver 1010, the controller 1020, and the memory 1030 may be electrically connected or coupled to each other. The transceiver 1010 may transmit a signal to and receive a signal from other network entities, such as another node and/or a UE, or the like. In an embodiment of the disclosure, the transceiver 1010 may be omitted. In this case, the controller 1020 may be configured to execute instructions (including computer programs) stored in the memory 1030 to control the overall operation of the node 1000, thereby implementing the operations of the node described herein, the node 1000 may correspond to an element described in FIG. 1 or FIG. 2.

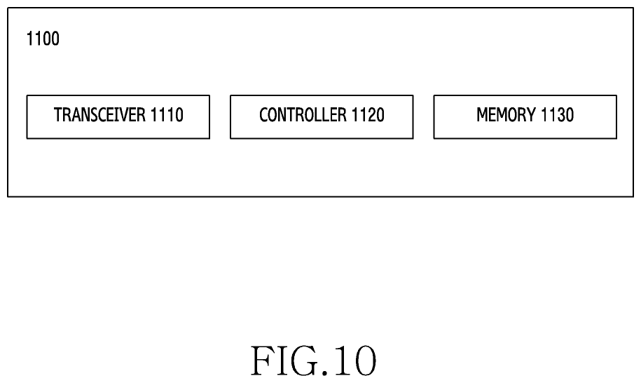

FIG. 10 illustrates a block diagram of a user equipment according to an embodiment of the disclosure.

In the disclosure, the terms “user equipment”, “user terminal device”, “user terminal”, and “terminal device” may be used interchangeably.

Referring to FIG. 10, a user equipment 1100 includes a transceiver 1110, a controller 1120, and a memory 1130. Under the control of the controller 1120 (which may be implemented as one or more processors), the user equipment 1100 (including the transceiver 1110 and the memory 1130) is configured to perform the operations of the user equipment described herein. Although shown as separate entities, the transceiver 1110, controller 1120, and memory 1130 may be implemented as a single entity, such as a single chip. The transceiver 1110, the controller 1120, and the memory 1130 may be electrically connected or coupled to each other. The transceiver 1110 may transmit a signal to and receive a signal from other network entities, such as a node, another UE, or the like. In an embodiment of the disclosure, the transceiver 1110 may be omitted. In this case, the controller 1120 may be configured to execute instructions (including computer programs) stored in the memory 1130 to control the overall operation of the user equipment 1100, thereby performing the operations of the user equipment described herein, the user equipment 1100 may correspond to an user equipment described in previous figures.

In the disclosure, the terms “node”, “user equipment”, “device”, and “apparatus” may be used interchangeably.

In one embodiment, a method performed by a second node in a wireless communication system, the method comprising: receiving a first message from a first node, the first message comprising: identity information of data, at least one time information, and at least one configuration information corresponding to the at least one time information; and transmitting data indicated by the identity information of data based on the first message.

In one embodiment, the transmitting of the data indicated by the identity information of data comprises: transmitting the data within time indicated by the at least one time information based on the at least one configuration information.

In one embodiment, the first message further comprises at least one of: first indication information for indicating one configuration information in the at least one configuration information, information for indicating associated data, information for indicating a mapping relationship of the data, information for indicating an applicable time range, or information for indicating a quality of service (QoS) parameter that the second node is requested to satisfy.

In one embodiment, wherein the first indication information or the second indication information comprises at least one of: configuration identity information, information for indicating a time window, information for indicating a quality of service (QoS) parameter that the second node needs to adopt, information for indicating a transmission configuration that the second node needs to adopt, information for indicating a configuration of data that the second node needs to adopt, information for indicating a configuration that needs to be activated, or information for indicating a configuration that needs to be deactivated or suspended.

In one embodiment, the method further comprising: receiving a second message, the second message comprising second indication information for indicating one configuration information in the at least one configuration information.

In one embodiment, the at least one time information is used for indicating at least one time window and information related to the at least one time window.

In one embodiment, the at least one configuration information comprises information for indicating a setting of a Qquality of Sservice (QoS) parameter applicable to the data within a time window indicated by the at least one time information, and/or information for indicating a configuration related to the data requested by the first node.

In one embodiment, A method performed by a second node in a wireless communication system, the method comprising: receiving a first message from a first node, the first message comprising identity information of data and at least one configuration information, receiving a second message, the second message comprising second indication information for indicating one configuration information in the at least one configuration information, and transmitting data indicated by the identity information of data according to the configuration information indicated by the second message and/or the first message.

In one embodiment, the second message is received from the first node or a third node.

In one embodiment, the first message further comprises: at least one time information corresponding to the at least one configuration information.

In one embodiment, A method performed by a first node in a wireless communication system, the method comprising: acquiring time information related to data; and transmitting a first message to a second node based on the time information related to data, the first message comprising identity information of the data and at least one configuration information.

In one embodiment, the first message further comprises at least one time information corresponding to the at least one configuration information.

In one embodiment, the first message further comprises first indication information for indicating one configuration information in the at least one configuration information.

In one embodiment, the method further comprising transmitting a second message to the second node, the second message comprising second indication information for indicating one configuration information in the at least one configuration information.

In one embodiment, the first indication information or the second indication information comprises at least one of: configuration identity information, information for indicating a time window, information for indicating a quality of service (QoS) parameter that the second node needs to adopt, information for indicating a transmission configuration that the second node needs to adopt, information for indicating a configuration of data that the second node needs to adopt, information for indicating a configuration that needs to be activated, or information for indicating a configuration that needs to be deactivated or suspended.

In one embodiment, the method further comprising: transmitting a third message to a third node, the third message comprising time information and at least one configuration information, and receiving a fourth message from the third node.

In one embodiment, the time information related to data comprises at least one of: information for indicating at least one time window, information for indicating a setting of the QoS parameter applicable to the data within a time window, or information for indicating the configuration related to the data.

In one embodiment, the information for indicating at least one time window comprises at least one of: identity information of a time window, information for indicating a start position of the time window, information for indicating a length of the time window, information for indicating an end position of the time window, information for indicating an amount of data that needs to be and/or has been transmitted within the time window, information for indicating an offset required to start the time window, information for indicating a cycle of the time window, information for indicating the a number of time windows, information for indicating whether the second node is able to continue to use the configuration information corresponding to the time window after the time window ends, information for indicating time allowed for the second node to continue data transmission according to a corresponding configuration after the time window ends, information for indicating the amount of data allowed for the second node to continue data transmission according to the corresponding configuration after the time window ends, or information for indicating a length of a timer related to the time window.

In one embodiment, the information for indicating the setting of the QoS parameter applicable to the data within a time window comprises at least one of: information for indicating the setting of the QoS parameter applicable to the data indicated by the identity information of data, information for indicating an optional QoS parameter applicable to the data indicated by the identity information of the data, or identity information of the QoS parameter.

In one embodiment, the information for indicating the configuration related to the data comprises at least one of: configuration identity information, information for indicating a configuration required when transmitting data, or information for indicating a configuration required when configuring data transmission.

In one embodiment, a method performed by a third node in a wireless communication system, the method comprising: receiving a third message from a first node, the third message comprising time information and at least one configuration information, and sending a second message to a second node, the second message comprising indication information for indicating one configuration information in the at least one configuration information.

In one embodiment, the method further comprising: sending a fourth message to the first node, the fourth message comprising at least one of: identity information of data, information for indicating a quality of service (QoS) parameter can be satisfied and/or a transmission configuration adopted and/or configuration information of data adopted by the second node within a time window, information for indicating a mapping mode of data adopted by the second node, or information for indicating the QoS parameter can be satisfied by the second node.

In one embodiment, A first node comprising: a transceiver configured to transmit and receive a signal, and at least one processor coupled to the transceiver.

In one embodiment, the at least one processor is configured to perform operations comprising: acquiring time information related to data, and transmitting a first message to a second node based on the time information related to data, the first message comprising identity information of the data and at least one configuration information.

Those skilled in the art may realize that the disclosure can be implemented in other specific forms without changing the technical idea or basic features of the disclosure. Therefore, it should be understood that the above-mentioned embodiments are merely examples and not limitative. The scope of the disclosure is defined by the appended claims rather than the detailed description. Therefore, it should be understood that all modifications or changes derived from the meaning and scope of the appended claims and their equivalents fall within the scope of the disclosure.

In the above-described embodiments of the disclosure, all operations and messages may be selectively performed or may be omitted. In addition, the operations in each embodiment do not need to be performed sequentially, and the order of operations may vary. Messages do not need to be transmitted in order, and the transmission order of messages may change. Each operation and transfer of each message can be performed independently.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a second node in a wireless communication system, the method comprising:
receiving a first message from a first node, the first message comprising identity information of data, at least one time information, and at least one configuration information corresponding to the at least one time information; and
transmitting data indicated by the identity information of data based on the first message.

2. The method of claim 1, wherein the transmitting of the data indicated by the identity information of data comprises:
transmitting the data within time indicated by the at least one time information based on the at least one configuration information.

3. The method of claim 1, wherein the first message further comprises at least one of:
first indication information for indicating one configuration information in the at least one configuration information;
information for indicating associated data, information for indicating a mapping relationship of the data;
information for indicating an applicable time range; or
information for indicating a quality of service (QoS) parameter that the second node is requested to satisfy.

4. The method of claim 3, wherein the first indication information or the second indication information comprises at least one of:
configuration identity information;
information for indicating a time window;
information for indicating a quality of service (QoS) parameter that the second node needs to adopt;
information for indicating a transmission configuration that the second node needs to adopt;
information for indicating a configuration of data that the second node needs to adopt;
information for indicating a configuration that needs to be activated; or
information for indicating a configuration that needs to be deactivated or suspended.

5. The method of claim 1, further comprising:
receiving a second message, the second message comprising second indication information for indicating one configuration information in the at least one configuration information.

6. The method of claim 1,
wherein the at least one time information is used for indicating at least one time window and information related to the at least one time window, and
wherein the at least one configuration information comprises information for indicating a setting of a quality of service (QoS) parameter applicable to the data within a time window indicated by the at least one time information, and/or information for indicating a configuration related to the data requested by the first node.

7. A method performed by a second node in a wireless communication system, the method comprising:
receiving a first message from a first node, the first message comprising identity information of data and at least one configuration information;
receiving a second message, the second message comprising second indication information for indicating one configuration information in the at least one configuration information; and
transmitting data indicated by the identity information of data according to the configuration information indicated by the second message and/or the first message.

8. The method of claim 7, wherein the second message is received from the first node or a third node.

9. The method of claim 7, wherein the first message further comprises at least one time information corresponding to the at least one configuration information.

10. A method performed by a first node in a wireless communication system, the method comprising:
acquiring time information related to data; and
transmitting a first message to a second node based on the time information related to data, the first message comprising identity information of the data and at least one configuration information.

11. The method of claim 10, wherein the first message further comprises at least one time information corresponding to the at least one configuration information.

12. The method of claim 10, wherein the first message further comprises first indication information for indicating one configuration information in the at least one configuration information.

13. The method of claim 10, further comprising:
transmitting a second message to the second node, the second message comprising second indication information for indicating one configuration information in the at least one configuration information.

14. The method of claim 13, wherein the first indication information or the second indication information comprises at least one of:
configuration identity information;
information for indicating a time window;
information for indicating a quality of service (QoS) parameter that the second node needs to adopt;
information for indicating a transmission configuration that the second node needs to adopt;
information for indicating a configuration of data that the second node needs to adopt;
information for indicating a configuration that needs to be activated; or
information for indicating a configuration that needs to be deactivated or suspended.

15. The method of claim 10, further comprising:
transmitting a third message to a third node, the third message comprising time information and at least one configuration information; and
receiving a fourth message from the third node.

16. The method of claim 10,
wherein the time information related to data comprises at least one of: information for indicating at least one time window, information for indicating a setting of the QoS parameter applicable to the data within a time window, or information for indicating the configuration related to the data.

17. The method of claim 16,
wherein the information for indicating at least one time window comprises at least one of:
identity information of a time window;
information for indicating a start position of the time window;
information for indicating a length of the time window;
information for indicating an end position of the time window;
information for indicating an amount of data that needs to be and/or has been transmitted within the time window;
information for indicating an offset required to start the time window, information for indicating a cycle of the time window;
information for indicating a number of time windows;
information for indicating whether the second node is able to continue to use the configuration information corresponding to the time window after the time window ends;
information for indicating time allowed for the second node to continue data transmission according to a corresponding configuration after the time window ends;
information for indicating the amount of data allowed for the second node to continue data transmission according to the corresponding configuration after the time window ends; or
information for indicating a length of a timer related to the time window,
wherein the information for indicating the setting of the QoS parameter applicable to the data within a time window comprises at least one of:
information for indicating the setting of the QoS parameter applicable to the data indicated by the identity information of data;
information for indicating an optional QoS parameter applicable to the data indicated by the identity information of the data; or
identity information of the QoS parameter, and
wherein the information for indicating the configuration related to the data comprises at least one of:
configuration identity information, information for indicating a configuration required when transmitting data; or
information for indicating a configuration required when configuring data transmission.

18. A method performed by a third node in a wireless communication system, the method comprising:
receiving a third message from a first node, the third message comprising time information and at least one configuration information; and
sending a second message to a second node, the second message comprising indication information for indicating one configuration information in the at least one configuration information.

19. The method of claim 18, further comprising:
sending a fourth message to the first node, the fourth message comprising at least one of:
identity information of data, information for indicating a quality of service (QoS) parameter can be satisfied and/or a transmission configuration adopted and/or configuration information of data adopted by the second node within a time window;
information for indicating a mapping mode of data adopted by the second node; or
information for indicating the QoS parameter can be satisfied by the second node.

20. A first node comprising:
a transceiver configured to transmit and receive a signal; and
at least one processor coupled to the transceiver,
wherein the at least one processor is configured to perform operations comprising:
acquiring time information related to data, and
transmitting a first message to a second node based on the time information related to data, the first message comprising identity information of the data and at least one configuration information.
